(19) United States
(12) Patent Application Publication
(10) Pub. No.: US 2010/0201756 A1
(43) Pub. Date: Aug. 12, 2010

(54) PIEZOELECTRIC ACTUATOR, LIQUID DISCHARGING HEAD, AND METHOD FOR MANUFACTURING PIEZOELECTRIC ACTUATOR

(75) Inventors: Hideki KUWAJIMA, Kyoto (JP); Fumiyo TOUJOU, Nara (JP); Hiromi KITA, Nara (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/725,524

(22) Filed: Mar. 17, 2010

Related U.S. Application Data
(63) Continuation of application No. PCT/JP2009/003256, filed on Jul. 10, 2009.

(30) Foreign Application Priority Data
Jul. 24, 2008 (JP) 2008-191053
Jul. 24, 2008 (JP) 2008-191168
Jul. 24, 2008 (JP) 2008-191170

(51) Int. Cl. B41J 2/045

(52) U.S. Cl. 347/71

(57) ABSTRACT

A piezoelectric actuator includes a piezoelectric sheet, a first electrode provided on a front surface of the piezoelectric sheet, a second electrode provided on a reverse surface of the piezoelectric sheet and opposing at least a portion of the first electrode, and a fixed portion for supporting the piezoelectric sheet with the first and second electrodes provided thereon from a front surface side and a reverse surface side of the piezoelectric sheet. A sliding layer is provided between the fixed portion and the first electrode and between the fixed portion and the second electrode so as to allow for a relative displacement between the piezoelectric sheet and the fixed portion.

### CROSS-REFERENCE TO RELATED APPLICATION

This is a continuation of PCT International Application PCT/JP2009/003256 filed on Jul. 10, 2009, which claims priority to Japanese Patent Application Nos. 2008-191053, 2008-191168 and 2008-191170, all filed on Jul. 24, 2008. The disclosures of these applications including the specifications, the drawings, and the claims are hereby incorporated by reference in its entirety.

### TECHNICAL FIELD

The present disclosure relates to a piezoelectric actuator, a liquid discharging head having the same, and a method for manufacturing a piezoelectric actuator.

### BACKGROUND

A liquid discharging head for discharging a liquid onto a medium of any of various types to thereby form a predetermined pattern on the medium at least includes a pressure chamber filled with a liquid, a nozzle that communicates with the pressure chamber, and a piezoelectric actuator for applying a pressure on the liquid in the pressure chamber. That is, a liquid discharging head applies a pressure on the liquid in the pressure chamber as the piezoelectric actuator deforms, thereby discharging the liquid through the nozzle.

For example, Japanese Patent Publication No. H09-029965 discloses a liquid discharging head including many nozzles arranged to form nozzle rows and including many pressure chambers arranged so as to realize a one-to-one correspondence with the nozzles. The piezoelectric actuator of the liquid discharging head includes a plurality of piezoelectric element portions, each including a plate-like piezoelectric layer and two plate-like electrodes laminated on the piezoelectric layer so that the piezoelectric layer is interposed therebetween. Specifically, in this piezoelectric actuator, each piezoelectric element portion has a thin-plate shape so as to accommodate the nozzle pitch (the interval between nozzles), and base-end portions of the thin-plate-shaped piezoelectric element portions are attached with each other with an insulating layer interposed therebetween. Therefore, the piezoelectric actuator has a block-shaped configuration including a plurality of piezoelectric element portions arranged in a comb-teeth-like pattern.

For example, Japanese Patent Publication No. 2002-292864 discloses a liquid discharging head having a piezoelectric actuator including piezoelectric element portions to be used as laminate piezoelectric members and non-piezoelectric element portions not to be used as piezoelectric members, alternating with each other in the row direction of the pressure chamber. The piezoelectric actuator includes a plurality of green sheets laminated in the height direction of the pressure chamber perpendicular to the row direction to thereby form a block of laminate piezoelectric members, wherein the block is provided with a plurality of slits running in the lamination direction with a predetermined interval therebetween in the row direction of the pressure chamber, with the slits partitioning the piezoelectric element portions and the non-piezoelectric element portions from each other.

### SUMMARY

Now, with such a liquid discharging head, it is necessary to further narrow the nozzle pitch in order to further increase the resolution of pattern formation. As the nozzle pitch is narrowed, the width (the width in the nozzle row direction) of each pressure chamber to which a corresponding nozzle communicates is also narrowed, and it is therefore necessary to also narrow the width of each piezoelectric element portion attached to a corresponding pressure chamber.

On the other hand, with such a liquid discharging head, in order to allow a high-viscosity liquid to be discharged therefrom, it is necessary to further increase the pressure to be applied to the liquid in the pressure chamber, and it is necessary to increase the amount of displacement of each piezoelectric element portion.

The present inventors have realized that the following problems will arise when one attempts to further increase the resolution of pattern formation with a liquid discharging head. That is, it is necessary to further narrow the nozzle pitch in order to increase the resolution, and as the nozzle pitch is narrowed, the width (the width in the nozzle row direction) of each pressure chamber to which a corresponding nozzle communicates is also narrowed. Therefore, with the liquid discharging head disclosed in Japanese Patent Publication No. H09-029965, it is necessary to narrow the interval between the piezoelectric element portions while narrowing the width of each piezoelectric element portion attached to a corresponding pressure chamber. This configuration makes it difficult to ensure the rigidity of each piezoelectric element portion. In addition, in order to allow a high-viscosity liquid to be discharged, it is necessary to further increase the pressure to be applied to the liquid in the pressure chamber, and it is necessary to increase the amount of displacement of each piezoelectric element portion. With the liquid discharging head disclosed in Japanese Patent Publication No. H09-029965, it is necessary to increase the height of each piezoelectric element portion (the height to which they project in a comb-teeth-like pattern). However, a piezoelectric actuator of such a configuration also makes it difficult to ensure the rigidity of each piezoelectric element portion.

Similarly, with the liquid discharging head disclosed in Japanese Patent Publication No. 2002-292864, it is necessary to narrow the interval between piezoelectric element portions and to increase the height of the piezoelectric element portions in order to increase the resolution or to allow a high-viscosity liquid to be discharged. This reduces the area of the laminated piezoelectric element portion, and makes it difficult to ensure the rigidity of each piezoelectric element portion.

Moreover, with either one of the configurations disclosed in Japanese Patent Publication No. H09-029965 and Japanese Patent Publication No. 2002-292864, there is a spatial gap between piezoelectric element portions. This gap prevents the physical crosstalk (interference) occurring when driving adjacent pressure chambers individually. However, where one attempts to reduce the nozzle pitch, there are process problems caused by the gap itself or in view of the gap machining precision.

The technique disclosed herein is advantageous in that in a piezoelectric actuator including at least one piezoelectric element portion, it is possible to increase the amount of displacement while ensuring a sufficient rigidity even when the thickness of the piezoelectric element portion is reduced or the height thereof is increased.

A piezoelectric actuator disclosed herein includes: a piezoelectric sheet having a front surface and a reverse surface; a first electrode provided on the front surface of the piezoelectric sheet; a second electrode provided on the reverse surface of the piezoelectric sheet and opposing at least a portion of the first electrode; a fixed portion for supporting the piezoelectric sheet with the first and second electrodes provided thereon from a front surface side and a reverse surface side of the piezoelectric sheet; and a sliding layer provided between the fixed portion and the first electrode and between the fixed portion and the second electrode so as to allow for a relative displacement between the piezoelectric sheet and the fixed portion.

With the piezoelectric actuator described above, a piezoelectric element portion including a piezoelectric sheet and first and second electrodes is supported by a fixed portion via a sliding layer. As a result, it is possible to ensure the rigidity of the piezoelectric element portion even if the thickness of the piezoelectric element portion is reduced or if the height of the piezoelectric element portion is increased.

### BRIEF DESCRIPTION OF THE DRAWINGS

FIG. 1A is a perspective view of an example head unit.

FIG. 1B illustrates a nozzle surface of the head unit.

FIG. 1C is a configuration diagram of an example line head including a plurality of head units.

FIG. 2 is a cross-sectional view of the example head unit.

FIG. 3 is a perspective view of a main part showing the internal structure of the head unit.

FIG. 4A is a cross-sectional view of the head unit.

FIG. 4B is an enlarged cross-sectional view of the head unit.

FIG. 5 is a configuration diagram of the head unit showing a piezoelectric actuator as viewed from a nozzle plate side.

FIG. 6 is a schematic configuration diagram showing a liquid circulating system.

FIG. 7 illustrates a driving voltage waveform applied to the piezoelectric actuator.

FIG. 8A illustrates a state of the piezoelectric actuator when a positive voltage is applied to a control electrode.

FIG. 8B illustrates a state of the piezoelectric actuator when a negative voltage is applied to the control electrode.

FIG. 8C illustrates a state of the piezoelectric actuator when a ground potential is applied to the control electrode.

FIG. 9 shows a plan view showing a nozzle surface of an example line head, a plan view showing a portion of an example head unit, and a plan view showing a portion of an example piezoelectric actuator.

FIG. 10 is a cross-sectional view illustrating the head unit taken along line X-X of FIG. 9.

FIG. 11 is a perspective view of the piezoelectric actuator.

FIG. 12 is an exploded perspective view of the piezoelectric actuator.

FIG. 13 is a plan view of a piezoelectric sheet.

FIG. 14A is a perspective view showing an electrode end surface of the piezoelectric actuator.

FIG. 14B is an enlarged view of an electrode end surface.

FIG. 15 is a perspective view showing how piezoelectric sheets are laminated while manufacturing the piezoelectric actuator.

FIG. 16 is a perspective view showing an end portion of a laminate.

FIG. 17 is a perspective view illustrating a structure in which a flexible printed wiring board is attached to the piezoelectric actuator.

FIG. 18 is a perspective view illustrating a structure in which a rigid substrate is attached to the piezoelectric actuator.

FIG. 19 is a cross-sectional view showing an example of an actuator driving circuit.

FIG. 20 is a circuit diagram of the actuator driving circuit.

FIG. 21 is a cross-sectional view showing an example head unit.

FIG. 22 is a cross-sectional view showing an example head unit.

FIG. 23 is a cross-sectional view showing an example head unit.

FIG. 24 illustrates a cutting direction of a piezoelectric actuator.

FIG. 25 illustrates a manufacturing concept of a piezoelectric actuator.

FIG. 26 illustrates a manufacturing concept of the piezoelectric actuator.

FIG. 27 illustrates a variation of an electrode pattern of a piezoelectric sheet.

FIG. 28 is a perspective view of a main part showing piezoelectric sheets shown in FIG. 27 laminated together.

FIG. 29 is a cross-sectional view showing a manufacturing process of a piezoelectric actuator.

FIG. 30 shows a cross-sectional view of a piezoelectric actuator and a manufacturing process thereof.

### DETAILED DESCRIPTION

An example piezoelectric actuator includes: a piezoelectric sheet having a front surface and a reverse surface; a first electrode provided on the front surface of the piezoelectric sheet; a second electrode provided on the reverse surface of the piezoelectric sheet and opposing at least a portion of the first electrode; a fixed portion for supporting the piezoelectric sheet with the first and second electrodes provided thereon from a front surface side and a reverse surface side of the piezoelectric sheet; and a sliding layer provided between the fixed portion and the first electrode and between the fixed portion and the second electrode so as to allow for a relative displacement between the piezoelectric sheet and the fixed portion. Here, the sliding layer may be located between the fixed portion and the first electrode and between the fixed portion and the second electrode, and may or may not be in direct contact with the first electrode and the second electrode. For example, another piezoelectric sheet may be provided between the first electrode and the sliding layer, and another piezoelectric sheet may be provided between the second electrode and the sliding layer.

With this configuration, the piezoelectric element portion including the piezoelectric sheet and the first and second electrodes is supported by the fixed portion via the sliding layer. Therefore, it is possible to ensure the rigidity of the piezoelectric element portion even if the thickness of the piezoelectric element portion is reduced or the height of the piezoelectric element portion is increased.

In one embodiment of the piezoelectric actuator, a plurality of laminates are laminated together with the fixed portion sandwiched therebetween to thereby form an actuator block, wherein each of the laminates is obtained by laminating together the piezoelectric sheet, the first and second electrodes and the sliding layer. With this configuration, the piezoelectric actuator layout density can be increased.

In one embodiment, the fixed portion is formed by an un-polarized piezoelectric member. Using the same material for the fixed portion and the piezoelectric sheet eliminates the distortion during the sintering of the piezoelectric member.

In one embodiment, the sliding layer is formed primarily by a molybdenum compound. In one embodiment, the sliding layer is formed primarily by molybdenum disulfide. Then, it is possible to achieve a desirable relative displacement between the piezoelectric sheet and the fixed portion. In one embodiment, the sliding layer is formed primarily by graphite. In one embodiment, the sliding layer is formed primarily by silicon nitride. In one embodiment, the sliding layer is formed primarily by n-silicon nitride. In one embodiment, the sliding layer is formed primarily by hexagonal boron nitride.

In one embodiment, the first electrode is a control electrode receiving a control potential for displacing the piezoelectric sheet, and the second electrode is a ground electrode.

With this configuration, it is possible to control the amount of displacement of the piezoelectric sheet by applying a control potential to the control electrode.

In one embodiment, the first and second electrodes are formed primarily by graphite. With this configuration, the electrode and the sliding layer can each serve also as the other, thereby simplifying the configuration of the piezoelectric actuator.

In one embodiment, the sliding layer is formed by a flexible material.

In one embodiment, the piezoelectric sheet has a displaced end surface displaced in a piezoelectric constant d₃₁ direction. The displaced end surface directly pushes out the liquid, thereby significantly improving the essential power of the piezoelectric actuator.

In one embodiment, the piezoelectric actuator further includes a connection electrode connected to the first electrode and a connection electrode connected to the second electrode, wherein a surface of the actuator block which is facing in a direction perpendicular to the lamination direction and on which the first and second electrodes are provided is a driven end surface, and the connection electrode extends in a direction perpendicular to the lamination direction and is exposed on an electrode end surface of the actuator block which is opposite to the driven end surface.

With this configuration, a control electrode can be extracted from the surface of the piezoelectric actuator that is opposite to the driven end surface (the liquid discharging side), thereby enabling one to achieve a smaller size when a line head, or the like, is formed by combining a plurality of piezoelectric actuators together.

In one embodiment, a substrate is connected directly to the electrode end surface of the actuator block. In one embodiment, the substrate is connected to the actuator block by an ACF (Anisotropic Conductive Film).

In one embodiment, the substrate is a flexible substrate. In one embodiment, the substrate is a rigid substrate. In one embodiment, the rigid substrate includes a TFT opposing the electrode end surface of the actuator block.

In one embodiment, the fixed portion of the actuator block that is located outermost in the lamination direction has a smaller thickness than the other fixed portions. Where a plurality of actuator blocks are arranged side-by-side to achieve an elongated structure, the pitch between piezoelectric element portions will be constant through adjacent actuator blocks.

In one embodiment, the piezoelectric sheet and the fixed portion are displaced relative to each other in a direction along a boundary plane direction via the sliding layer.

An example liquid discharging head includes: a piezoelectric actuator described above; at least one pressure chamber a portion of which is partitioned by the piezoelectric actuator; and at least one nozzle communicating with the pressure chamber, wherein the piezoelectric actuator is driven to apply a pressure on a liquid loaded in the pressure chamber, thereby discharging a droplet through the nozzle. With this liquid discharging head, it is possible to achieve a high discharging power and a high resolution.

In one embodiment, a cover layer is provided between the piezoelectric actuator and the pressure chamber. The cover layer prevents the liquid and the piezoelectric actuator from directly contacting each other, and is therefore advantageous for eliminating limitations on the types of liquids that can be discharged.

In one embodiment, the liquid discharging head further includes: a circulation passageway for supplying the liquid to the pressure chamber; and a filter provided at a point along the circulation passageway. Foreign substances present in the pressure chamber are removed by the filter.

In one embodiment, the nozzles are arranged so as to form a nozzle row inclined with respect to a primary scanning direction, the piezoelectric actuator includes a plurality of actuator blocks each formed by laminating together a plurality of laminates with the fixed portions sandwiched therebetween, wherein each of the laminates is obtained by laminating together the piezoelectric sheet, the first and second electrodes and the sliding layer, and the plurality of actuator blocks are arranged side-by-side in the primary scanning direction, and each actuator block is arranged while being inclined with respect to the primary scanning direction so that a direction in which the end surface of the piezoelectric sheet extends coincides with the inclined nozzle row.

An example piezoelectric actuator includes: a first piezoelectric layer including a pair of piezoelectric sheets laminated together; a first electrode provided between the pair of piezoelectric sheets; a second piezoelectric layer laminated on the first piezoelectric layer; and a second electrode provided between the first piezoelectric layer and the second piezoelectric layer, wherein in the direction perpendicular to the lamination direction of the first piezoelectric layer and the second piezoelectric layer, a surface formed by the first piezoelectric layer and the second piezoelectric layer is a driven end surface, a surface formed by the first piezoelectric layer is a displaced end surface, and a surface formed by the second piezoelectric layer is a stationary end surface, wherein the first electrode and the second electrode are provided on the side of the driven end surface, and when a voltage is applied between the first electrode and the second electrode, the first piezoelectric layer is relatively displaced with respect to the second piezoelectric layer along the interlayer boundary plane therebetween, so that on the driven end surface, the displaced end surface is relatively displaced with respect to the stationary end surface.

With this configuration, as the second piezoelectric layer is laminated on the first piezoelectric layer, the first piezoelectric layer is supported by the second piezoelectric layer across the entire interlayer boundary plane. Therefore, it is possible to ensure the rigidity of the piezoelectric element portion including the first piezoelectric layer even if the thickness of the first piezoelectric layer is reduced.

The length of the piezoelectric element portion is set by the length of the first and second electrodes arranged in parallel to the interlayer boundary plane. Therefore, even if the length of the first and second electrodes is increased, it is possible to ensure the rigidity of the piezoelectric element portion since the first piezoelectric layer is supported by the second piezoelectric layer as described above.

Therefore, even if the thickness of the piezoelectric element portion is reduced or the length thereof is increased, it is possible to increase the amount of displacement thereof by increasing the length of the first and second electrodes, while ensuring a sufficient rigidity.

In one embodiment, the second piezoelectric layer is provided on opposite sides with the first piezoelectric layer sandwiched therebetween, and the second electrode is provided between the first piezoelectric layer and each of the two second piezoelectric layers.

In one embodiment, the piezoelectric actuator further includes a sliding layer of a solid lubricant and present between the first piezoelectric layer and the second piezoelectric layer which allows for a relative displacement between the first piezoelectric layer and the second piezoelectric layer.

This significantly reduces the resistance force against the relative displacement of the first piezoelectric layer with respect to the second piezoelectric layer in response to the application of a voltage between the electrodes. As a result, the conversion efficiency of the piezoelectric actuator is increased.

In one embodiment, the first electrode and a connection electrode connected to the first electrode are formed in a predetermined pattern on the surface of one of the pair of piezoelectric sheets. In one embodiment, the second electrode and a connection electrode connected to the second electrode are formed in a predetermined pattern on at least one of the surface of the first piezoelectric layer and the surface of the second piezoelectric layer.

In one embodiment, the second piezoelectric layer is formed by laminating together a plurality of piezoelectric sheets.

An example piezoelectric actuator has at least one laminate piezoelectric member including: a first piezoelectric sheet; a sliding layer of a solid lubricant laminated on the first piezoelectric sheet; a common electrode laminated on the sliding layer; a second piezoelectric sheet laminated on the first piezoelectric sheet so that the sliding layer and the common electrode are sandwiched therebetween; a control electrode laminated on the second piezoelectric sheet; a third piezoelectric sheet laminated on the second piezoelectric sheet so that the control electrode is sandwiched therebetween; another common electrode laminated on the third piezoelectric sheet; another sliding layer laminated on the other common electrode; and a fourth piezoelectric sheet laminated on the third piezoelectric sheet so that the other common electrode and the other sliding layer are sandwiched therebetween, wherein a portion formed by the second and third piezoelectric sheets on a driven end surface of the laminate piezoelectric member facing in a direction perpendicular to the lamination direction is a displaced end surface, wherein the displaced end surface is displaced in a direction perpendicular to the lamination direction when a voltage is applied between the control electrode and the common electrode.

In one embodiment, the piezoelectric actuator includes a plurality of the laminate piezoelectric members, and the plurality of laminate piezoelectric members are laminated together so that the driven end surfaces thereof are arranged side-by-side in the lamination direction.

An example piezoelectric actuator includes: an actuator block, including a first piezoelectric sheet, a second piezoelectric sheet, a third piezoelectric sheet and a fourth piezoelectric sheet repeatedly laminated in this order, wherein different predetermined electrode patterns are formed on the surfaces of the piezoelectric sheets, wherein the actuator block includes, provided on a driven end surface facing in a direction perpendicular to the lamination direction, a plurality of piezoelectric element portions each including the electrode and functioning as a piezoelectric element and a plurality of fixed portions being adjacent to the piezoelectric element portions and supporting the piezoelectric element portions, wherein the plurality of piezoelectric element portions and fixed portions are arranged alternating with each other and in a row in a primary scanning direction, which is the lamination direction of the piezoelectric sheets, to thereby form the piezoelectric element row, and a plurality of the piezoelectric element rows are provided on the driven end surface in a sub-scanning direction perpendicular to the primary scanning direction, and positions of the piezoelectric element portions of the piezoelectric element rows are different from one another between the plurality of piezoelectric element rows, with the amount by which the positions are shifted being set to a length that is an integral multiple of the thickness of the piezoelectric sheet.

In one embodiment, the positions of the piezoelectric element portions in the piezoelectric element row are shifted in the primary scanning direction by the thickness of one piezoelectric sheet with respect to the piezoelectric element portions of adjacent piezoelectric element rows in the sub-scanning direction.

In one embodiment, in the sub-scanning direction, the piezoelectric element portion in the 4N+1^{th} (where N is an integer greater than or equal to 0) piezoelectric element row is formed by the first piezoelectric sheet and the second piezoelectric sheet, the piezoelectric element portion in the 4N+2^{th} piezoelectric element row is formed by the second piezoelectric sheet and the third piezoelectric sheet, the piezoelectric element portion in the 4N+3^{th} piezoelectric element row is formed by the third piezoelectric sheet and the fourth piezoelectric sheet, and the piezoelectric element portion in the 4N+4^{th} piezoelectric element row is formed by the fourth piezoelectric sheet and the first piezoelectric sheet.

In one embodiment, electrodes formed on the surfaces of the various piezoelectric sheets include an electrode that functions as a control electrode in a predetermined piezoelectric element portion and an electrode that functions as a common electrode in a piezoelectric element portion different from the piezoelectric element portion.

An example piezoelectric actuator includes a plurality of laminate blocks, each including a plurality of types of piezoelectric sheets laminated together, wherein different predetermined electrode patterns are formed on surfaces of the piezoelectric sheets, wherein each of the laminate blocks includes, provided on a driven end surface facing in a direction perpendicular to the lamination direction, a plurality of piezoelectric element portions each including the electrode and functioning as a piezoelectric element and a plurality of fixed portions being adjacent to the piezoelectric element portions and supporting the piezoelectric element portions, wherein the plurality of piezoelectric element portions and fixed portions are arranged alternating with each other in a primary scanning direction, which is the lamination direction, to thereby form at least one piezoelectric element row, and the plurality of laminate blocks are attached together in the primary scanning direction and in a sub-scanning direction perpendicular to the primary scanning direction so that the piezoelectric element row extends in the primary scanning direction on the driven end surface and a plurality of the piezoelectric element rows are arranged side-by-side in the sub-scanning direction.

In one embodiment, a plurality of laminate blocks attached together in the sub-scanning direction are attached together while being shifted from one another in the primary scanning direction so that positions of the piezoelectric element portions in the piezoelectric element rows are different from one another between the plurality of piezoelectric element rows arranged in the sub-scanning direction.

In one embodiment, an amount by which a plurality of laminate blocks attached together in the sub-scanning direction are shifted from one another is set based on a thickness of the piezoelectric sheet.

An example method for manufacturing a piezoelectric actuator is directed to a method for manufacturing a piezoelectric actuator including: a first piezoelectric layer including first and second piezoelectric sheets laminated together and having a displaced end surface facing in a direction perpendicular to the lamination direction thereof; a first electrode provided between the first and second piezoelectric sheets at least in a portion on the displaced end surface side; a second piezoelectric layer laminated on the first piezoelectric layer and formed by at least one piezoelectric sheet having a stationary end surface that is arranged in the same direction as the displaced end surface to form a driven end surface together with the displaced end surface; a second electrode provided between the first piezoelectric layer and the second piezoelectric layer at least in a portion on the displaced end surface side so as to oppose the first electrode; and a sliding layer present between the first piezoelectric layer and the second piezoelectric layer which allows for a relative displacement of the first piezoelectric layer with respect to the second piezoelectric layer along an interlayer boundary plane therebetween in response to a voltage application between the first electrode and the second electrode.

The manufacturing method includes the steps of:

i) forming the first electrode on the first piezoelectric sheet at least in a portion on the displaced end surface side;

ii) laminating the second piezoelectric sheet on the first piezoelectric sheet so that the first electrode is sandwiched therebetween;

iii) forming the second electrode on the second piezoelectric sheet at least in a portion on the displaced end surface side;

iv) forming the sliding layer on the second electrode;

v) laminating a piezoelectric sheet which forms the second piezoelectric layer on the second piezoelectric sheet so that the second electrode and the sliding layer are sandwiched therebetween; and

vi) sintering the laminate produced through the above steps.

This piezoelectric actuator is manufactured by laminating together a plurality of laminate sheets and forming various electrodes and sliding layers on those laminate sheets. Therefore, it is possible to easily manufacture a piezoelectric actuator.

In one embodiment, the manufacturing method includes, after the step v), the steps of:

vii) forming another sliding layer on the second piezoelectric layer in a portion on the displaced end surface side;

viii) forming another second electrode on the other sliding layer

ix) laminating another first piezoelectric sheet on the second piezoelectric layer so that the other sliding layer and the other second electrode are sandwiched therebetween; and

x) repeating the steps i) to ix) (excluding the step vi)) a predetermined number of times and then performing the step vi).

In one embodiment, the formation of the first electrode, the formation of the second electrode and the formation of the sliding layer are each performed by a printing method.

In one embodiment, on an end surface of each of the piezoelectric sheets that is to form the driven end surface, a notch used for positioning when laminating the piezoelectric sheets is provided in advance at a position different from an area where the electrodes are formed.

An example method for manufacturing a piezoelectric actuator is directed to a method for manufacturing a piezoelectric actuator provided with at least one piezoelectric element row on a driven end surface expanding both in a primary scanning direction and in a sub-scanning direction perpendicular to the primary scanning direction, wherein a plurality of piezoelectric element portions which each include a control electrode and a common electrode and which are displaced in a direction perpendicular to the driven end surface and a plurality of fixed portions which support the piezoelectric element portions are arranged alternating with each other in the primary scanning direction, thereby forming the piezoelectric element row.

The manufacturing method includes the steps of:

i) producing a plurality of types of piezoelectric sheets formed by producing different electrode patterns including the control electrode and the common electrode on surfaces of the piezoelectric sheets;

ii) laminating the plurality of types of piezoelectric sheets in a predetermined order to thereby arrange the control electrodes and the common electrodes in a predetermined arrangement in a lamination direction, thereby forming the piezoelectric element row; and

iii) sintering the laminate produced through the above steps.

With this configuration, a piezoelectric actuator including a piezoelectric element row in which piezoelectric element portions and fixed portions are arranged alternating with each other is manufactured simply by repeatedly laminating together the piezoelectric sheets, on which predetermined electrode patterns have been formed in advance, in a predetermined order. Since the interval between the piezoelectric element portions in the piezoelectric element row is dictated by the thickness of each piezoelectric sheet, the piezoelectric element portions included in the piezoelectric actuator can be produced with a high positional precision.

In one embodiment, on the driven end surface of the piezoelectric actuator, a plurality of the piezoelectric element rows are provided in the sub-scanning direction, and positions of piezoelectric element portions in the piezoelectric element rows are different from one another between the plurality of piezoelectric element rows, with the amount by which the positions are shifted being set to a length that is an integral multiple of the thickness of the piezoelectric sheet, wherein the positions of the control electrodes and the common electrodes are shifted from one another in the sub-scanning direction between the plurality of types of piezoelectric sheets.

In one embodiment, a sliding layer is provided between each piezoelectric element portion and each fixed portion, the sliding layer allowing for a relative displacement of the piezoelectric element portion with respect to the fixed portion along a boundary plane therebetween, wherein the step of producing the plurality of types of piezoelectric sheets further includes forming the sliding layer by a printing method on an upper surface or a lower surface of the electrode together with the formation of the electrode.

In one embodiment, on each of the piezoelectric sheets, a control electrode is formed on a first end portion that is to form the driven end surface, and a connection electrode connected to the control electrode is extended to a second end portion opposite to the driven end surface side, wherein the step of producing the piezoelectric sheet includes the steps of: cutting a green sheet into a predetermined shape; forming a through hole on a second end portion of the green sheet, running through a thickness direction thereof; and printing a conductive material on a surface of the green sheet and an inner surface of the through hole to thereby produce a connection electrode for connecting the control electrode and the control electrode with the through hole, the manufacturing method further including the step of: iv) cutting off a second end portion of the laminate at a position that passes through the through hole, after sintering the laminate, so that the inner surface of the through hole is exposed on the cut surface.

In one embodiment, the manufacturing method further includes the step of: v) directly attaching a substrate to the cut surface to thereby electrically connect the inner surface of each through hole with the substrate.

In one embodiment, the manufacturing method further includes the step of: vi) providing a plurality of the sintered laminates, wherein the plurality of sintered laminates are attached together in at least one of the primary scanning direction and the sub-scanning direction.

In one embodiment, for the primary scanning direction, the plurality of sintered laminates are attached together so that the piezoelectric element rows are continuous with one another in the primary scanning direction. For the sub-scanning direction, the plurality of sintered laminates are attached together so that positions of the piezoelectric element portions arranged in the sub-scanning direction are shifted from one another in the primary scanning direction.

In one embodiment, the piezoelectric actuator is an actuator used in a liquid discharging head, in which the piezoelectric actuator is deformed to thereby apply a pressure on a liquid in a pressure chamber, thereby discharging the liquid through a nozzle that communicates with the pressure chamber, the manufacturing method further including the step of: vii) cutting a driven end surface of the sintered laminate after sintering the laminate to thereby form a partition wall for partitioning the pressure chamber.

In one embodiment, a plurality of piezoelectric element rows are provided in the sub-scanning direction on the driven end surface of the piezoelectric actuator, wherein positions of the piezoelectric element portions in the piezoelectric element rows are sequentially shifted from one another in the primary scanning direction between the piezoelectric element rows arranged in the sub-scanning direction, and the cutting process is performed in an inclined direction with respect to the sub-scanning direction so as to pass positions of the piezoelectric element portions through the plurality of piezoelectric element rows.

An example method for manufacturing a piezoelectric actuator is a method for manufacturing a piezoelectric actuator provided with a displaced portion on a laminate end surface formed by laminating together a plurality of piezoelectric sheets, the displaced portion being displaced in a normal direction to the laminate end surface. The piezoelectric sheets, sliding layers for reducing a friction in a sliding direction between the laminated piezoelectric sheets, control electrodes and common electrodes are laminated on the laminate end surface, and

a piezoelectric sheet A, the sliding layer, the common electrode, a piezoelectric sheet B, the control electrode, a piezoelectric sheet C, the common electrode, the sliding layer, and a piezoelectric sheet D

are repeatedly laminated together in this order.

In an example method for manufacturing a piezoelectric actuator,

a piezoelectric sheet A, the sliding layer, the common electrode, a piezoelectric sheet B, the control electrode, a piezoelectric sheet C, the common electrode, and the sliding layer

are repeatedly laminated together in this order.

An example method for manufacturing a piezoelectric actuator includes the steps of:

i) forming, in a portion of a piezoelectric sheet A corresponding to the displaced portion, a sliding layer for reducing a friction in a sliding direction between the laminated piezoelectric sheets and a common electrode;

ii) laminating a piezoelectric sheet B on the piezoelectric sheet A so that the sliding layer and the common electrode formed in the step i) are sandwiched therebetween, and forming a control electrode in a portion of the piezoelectric sheet B corresponding to the displaced portion;

iii) laminating a piezoelectric sheet C on the piezoelectric sheet B so that the control electrode formed in the step ii) is sandwiched therebetween, and forming a common electrode and a sliding layer in a portion of the piezoelectric sheet C corresponding to the displaced portion;

iv) laminating a piezoelectric sheet D on the piezoelectric sheet C so that the common electrode and the sliding layer formed in the step iii) are sandwiched therebetween; and

v) sintering the laminate produced through the above steps.

In one embodiment, the method further includes, after the step iv), the step of:

vi) laminating the piezoelectric sheet A on the piezoelectric sheet D, wherein

the steps i), ii), iii), iv) and vi) are repeated, and then the step v) is performed.

An example method for manufacturing a piezoelectric actuator includes the steps of:

i) forming, in a portion of a piezoelectric sheet A corresponding to the displaced portion, a sliding layer for reducing a friction in a sliding direction between the laminated piezoelectric sheets and a common electrode;

ii) laminating a piezoelectric sheet B on the piezoelectric sheet A so that the sliding layer and the common electrode formed in the step i) are sandwiched therebetween, and forming a control electrode in a portion of the piezoelectric sheet B corresponding to the displaced portion;

iii) laminating a piezoelectric sheet C on the piezoelectric sheet B so that the control electrode formed in the step ii) is sandwiched therebetween, and forming a common electrode and a sliding layer in a portion of the piezoelectric sheet C corresponding to the displaced portion; and

iv) sintering the laminate produced through the above steps.

In one embodiment, the method further includes, after the step iii), the step of:

v) laminating the piezoelectric sheet A on the piezoelectric sheet C so that the common electrode and the sliding layer formed in the step iii) are sandwiched therebetween, wherein

the steps i), ii), iii) and v) are repeated, and then the step iv) is performed.

Embodiments of piezoelectric actuators and liquid discharging heads will now be described with reference to the drawings. Note that the description of the following preferred embodiments is essentially merely illustrative.

### Embodiment 1

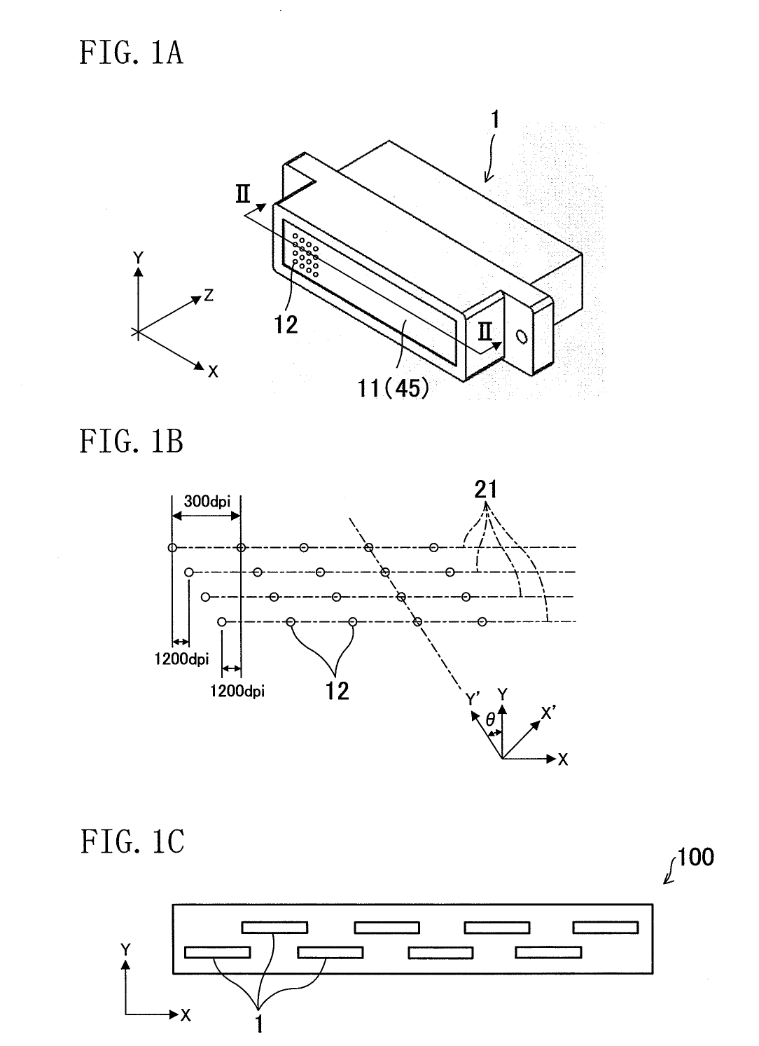

FIG. 1A is a perspective view of a liquid discharging head, FIG. 1B illustrates a nozzle surface of the liquid discharging head, and FIG. 1C is a configuration diagram of a line head 100 including a plurality of liquid discharging heads. Although not shown in the figures, the liquid discharging head (hereinafter referred to also as a “head unit 1”) forms a part of a liquid discharging apparatus used for, for example, printing so-called “documents” (printed matter), forming patterns during manufacturing processes of various devices, applying color filters for liquid crystal panels, EL (electroluminescent) materials and charge injection materials, for example, forming a uniform thin film such as a flood printing method. The head unit 1 discharges a liquid material, etc., onto a medium (not shown) from nozzles 12 arranged across a nozzle surface 11. A nozzle plate 45 includes a plurality of nozzles 12 punched therein, and includes, for example, four nozzle rows 21 each including a plurality of nozzles 12 spaced apart from each other at a predetermined equal interval (e.g., 300 dpi) in the X direction (primary scanning direction), as shown in FIG. 1B. The nozzle rows 21 are slightly shifted from one another in the X direction so that the nozzles 12 are in a staggered arrangement as viewed from the Y direction. In the present embodiment, the nozzles are arranged so that the nozzle density of an individual nozzle row 21 is, for example, 300 dpi in the X direction, and the nozzle density for the entire four nozzle rows 21 is, for example, 1200 dpi. The shift angle between the Y′ direction, i.e., the direction in which each nozzle row 21 extends, and the Y direction (sub-scanning direction) is θ.

A plurality of head units 1 are arranged in the X direction and in the Y direction to thereby form an elongated line head 100, as shown in FIG. 1C.

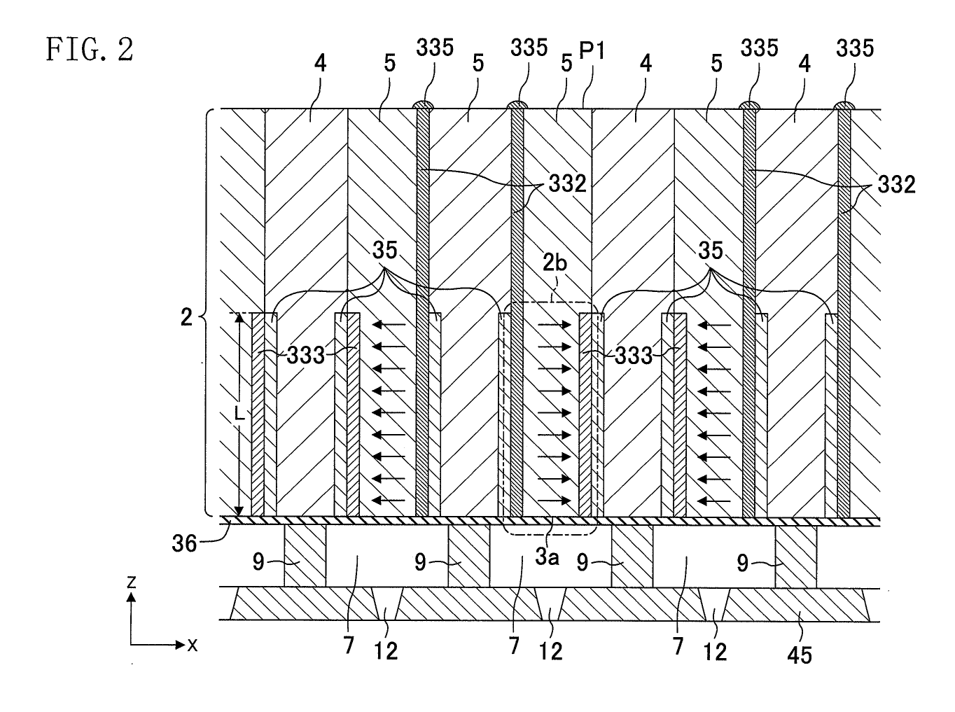

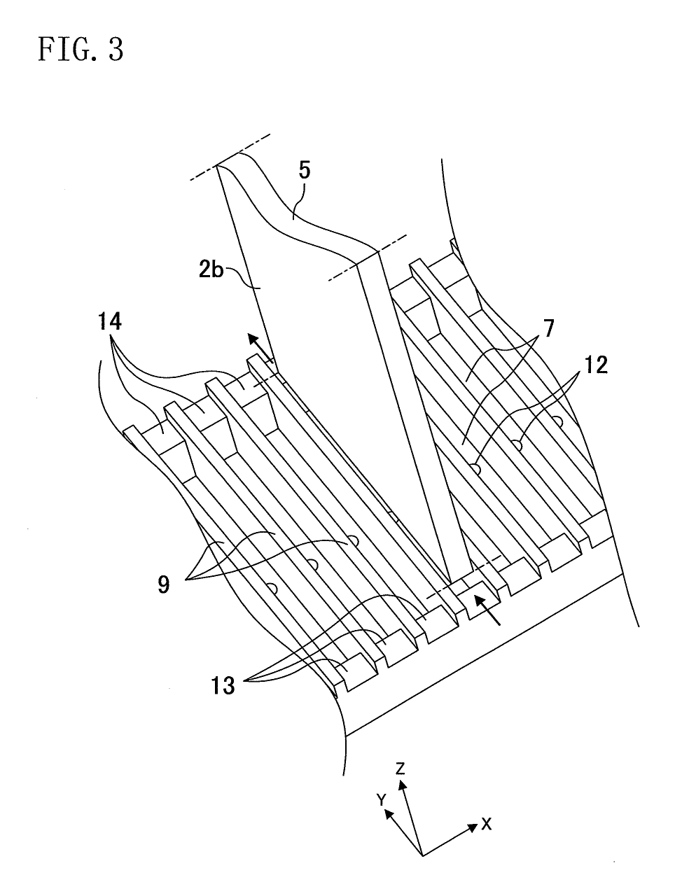

FIG. 2 is a cross-sectional view of the head unit 1, taken along line II-II in FIG. 1A. That is, FIG. 2 shows a cross section of one nozzle row 21 of the head unit 1.

The head unit 1 includes the nozzle plate 45 having the nozzles 12 therein, a piezoelectric actuator 2 obtained by laminating piezoelectric members together, and a pressure chamber partitioning member 9 provided between the nozzle plate 45 and the piezoelectric actuator 2.

The piezoelectric actuator 2 has a laminated structure. That is, the piezoelectric actuator 2 is formed by alternately laminating together piezoelectric sheets 5 and ceramic fixed sheets 4 in the X direction. Note that the fixed sheet 4 may be an un-polarized piezoelectric member. Using the same material for the piezoelectric sheets 5 and the adjacent fixed sheets 4 suppresses the occurrence of distortion during the sintering process performed when manufacturing the piezoelectric actuator 2 and makes it possible to maintain a high dimensional precision.

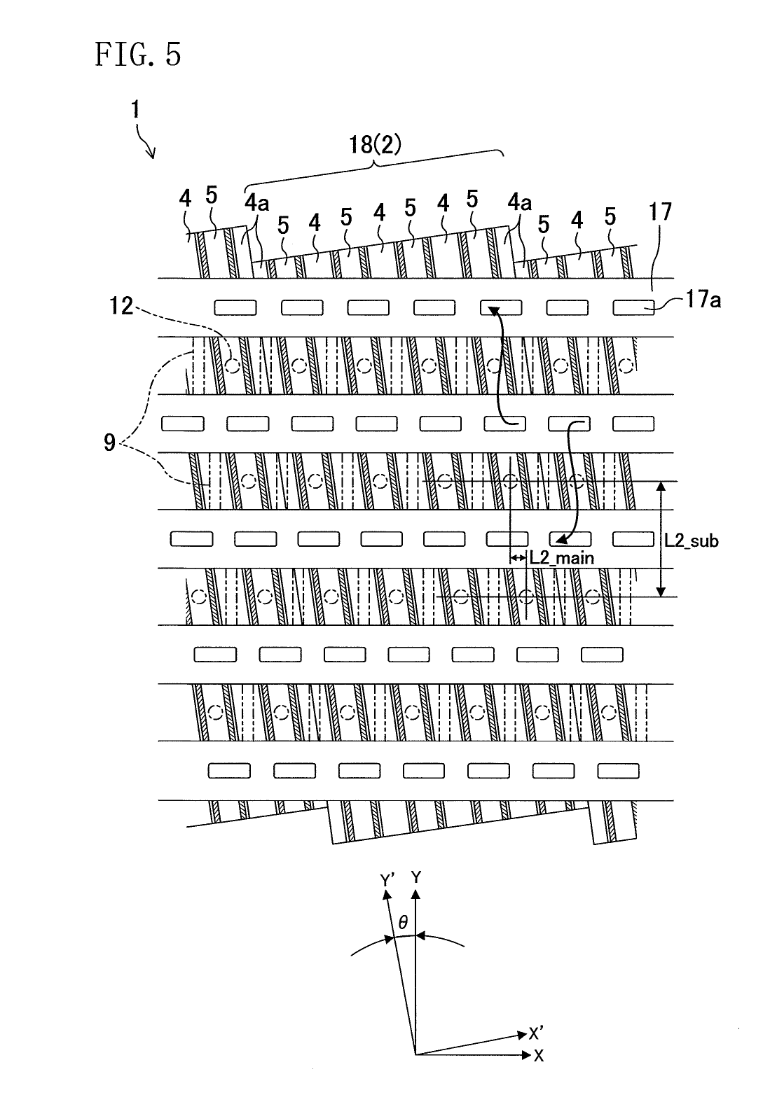

With the piezoelectric actuator 2, the piezoelectric sheets 5 and the fixed sheets 4 are so-called “green sheets” having a predetermined thickness (herein about 42.0 μm). The thickness is appropriately adjusted according to the resolution specifications of the head unit 1 (the nozzle pitch in the X direction, the nozzle pitch in the Y direction). Particular specifications will now be described with reference to FIG. 5. In FIG. 5, L2_sub denotes the interval in the Y direction between the adjacent nozzle rows 21, and L2_main denotes the nozzle pitch in the X direction including adjacent nozzle rows 21. Here, it is assumed that

L2_sub=4 mm

and

L2_main=25.4 mm/1200 dpi=21.2 μm

(see FIG. 1B).

Under this condition, θ as defined in FIG. 5 satisfies

tan θ=L2_main/L2_sub=21.2/4000.

Thus,

θ=0.3 deg.

It should be noted that the angle θ is exaggerated in FIG. 1B and FIG. 5 for the sake of ease of understanding.

Focusing on a single nozzle row 21, the nozzles 12 are arranged with a resolution of 300 dpi (see FIG. 1B), and the nozzle pitch NPX in the X direction is

NPX=25.4 mm/300 dpi=84.7 μm.

Then, since the angle between the X direction and the direction (the X′ direction) in which the piezoelectric sheets 5 and the fixed sheets 4 are laminated together is θ=0.3 deg, the nozzle pitch NPX′ (i.e., the pitch with which the piezoelectric sheets 5 and the fixed sheets 4 alternate with each other) in the X′ direction is

NPX′=NPX×cos θ=84.7 μm.

Assuming that the thickness of the piezoelectric sheet 5 and that of the fixed sheet 4 are equal to each other, the thickness of each sheet is 42.35 μm.

The thickness of the piezoelectric sheet 5 and that of the fixed sheet 4 may be different from each other. Since the thickness of a green sheet is 2 to 100 μm in practical use, the thickness of the piezoelectric sheet 5 and that of the fixed sheet 4 may each be appropriately selected within this range depending on the resolution specifications of the head unit 1.

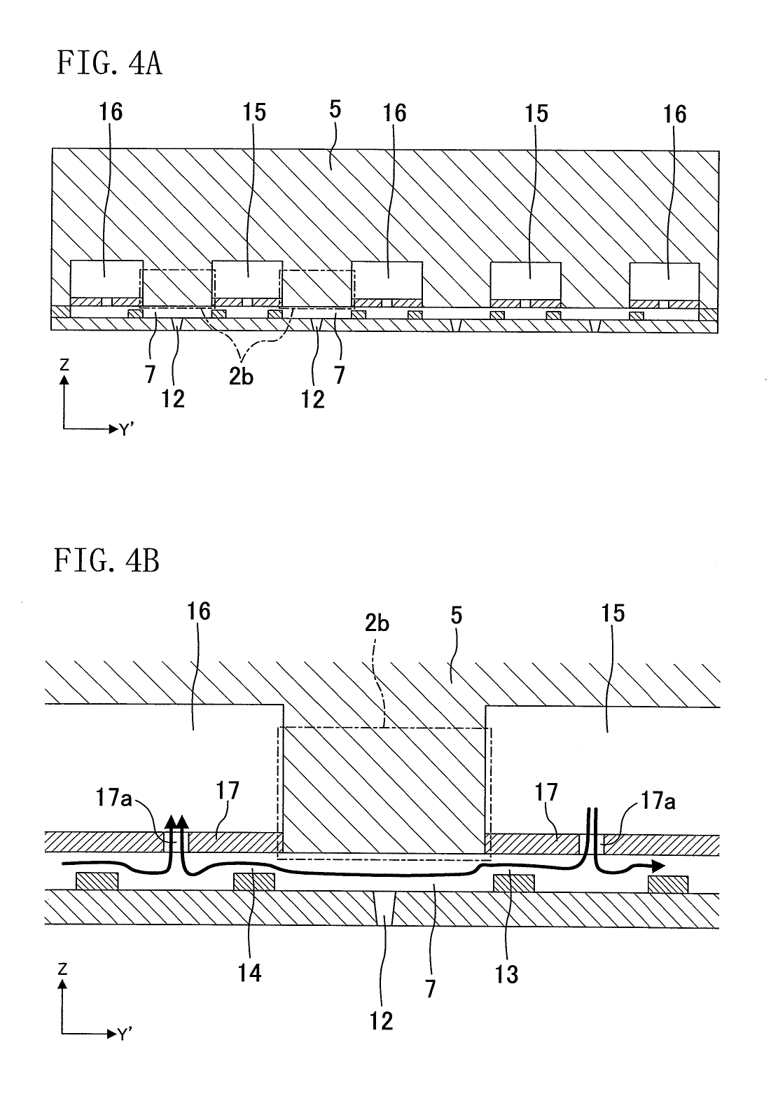

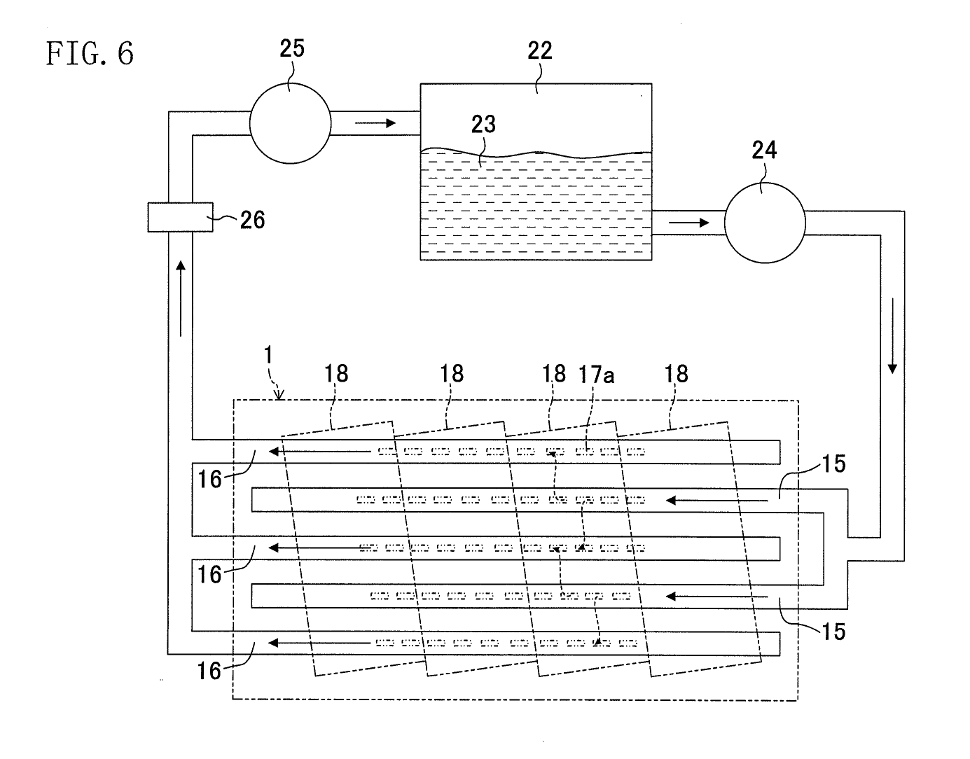

Note that a liquid supply passageway 15 or a liquid discharge passageway 16 is provided in a portion corresponding to L2_sub (the portion between adjacent nozzle rows 21) as described below (see FIG. 4, FIG. 6).

Referring back to FIG. 2, a control electrode 332 as a first electrode and a ground electrode 333 as a second electrode for applying an electric field to the piezoelectric sheet 5 are formed opposing the front and reverse sheet surfaces of the piezoelectric sheet 5. As a connection line 335 (e.g., connection electrode), the control electrode 332 is extended to, and exposed on, the side of the electrode end surface P1 opposite to a pressure chamber 7, and is connected to a piezoelectric actuator driving circuit (not shown). A plurality of ground electrodes 333 are shorted together via through holes (not shown), etc., to form a common electrode, and are extended to, and exposed on, the side of the electrode end surface P1. The control electrode 332, the ground electrode 333 and the connection line 335 can be patterned with aluminum or platinum, for example.

As shown in FIGS. 2 and 5, the piezoelectric actuator 2 includes a connection electrode (the connection line 335) connected to the first and second electrodes (the control electrode 332 and the ground electrode 333), and in the Z direction perpendicular to the direction in which the piezoelectric sheet 5, first and second electrodes and the fixed portion (the fixed sheets 4, 4) are laminated together, the side on which the control electrode 332 and the ground electrode 333 are provided is referred to as the driven end surface (the lower surface in FIG. 2), and the connection electrode can be said to be exposed on the electrode end surface P1 (the upper surface in FIG. 2) opposing the driven end surface.

A piezoelectric element portion 2b is a portion corresponding to the range interposed between the control electrode 332 and the ground electrode 333, more accurately, the range between sliding layers 35, 35 to be described below. The piezoelectric element portion 2b has a one-to-one correspondence with the pressure chamber 7, and the surface of each piezoelectric element portion 2b that is closer to the pressure chamber 7 serves as a displaced end surface 3a, which is displaced in the Z direction in response to a voltage application to thereby apply a pressure on a liquid 23 loaded in the pressure chamber 7 (shown only in FIG. 6). The displaced end surfaces 3a are arranged side-by-side in the X direction with the fixed sheet 4 interposed therebetween, and are arranged side-by-side in the Y′ direction with the supply passageway 15 or the discharge passageway 16 interposed therebetween.

Here, the length of the piezoelectric element portion 2b in the Z direction is defined by the length L with respect to the height of the ground electrode 333, and the amount of displacement of the piezoelectric element portion 2b in the presence of an applied voltage is set by the length L. With this configuration, the length L can be set long in the Z direction, and therefore the amount of displacement of each piezoelectric element portion 2b can be set to be large. That is, this configuration allows for an increase in the effective stroke of a portion that serves as the piezoelectric member, and it is particularly advantageous when a high-viscosity liquid is discharged. That is, although the shock wave applied by the piezoelectric actuator 2 to the liquid (and the vibration wave due to resonance) is damped in the pressure chamber 7 due to the damper effect of the high-viscosity liquid, the large stroke can compensate for the damping.

It is preferred that the length of the control electrode 332 and the ground electrode 333 is set to be as small as possible so that the capacitor capacitance of the piezoelectric element portion 2b will not be larger than necessary, in view of the responsiveness of the expansion/contraction of the piezoelectric element portion 2b. Therefore, a wiring pattern is designed so that these electrodes are not opposing each other in portions of the piezoelectric sheet 5 other than the piezoelectric element portion 2b.

Moreover, in the piezoelectric actuator 2 described above, the sliding layers 35, 35, obtained by making a solid lubricant into films, are provided between the control electrode 332 and the fixed sheet 4 and between the ground electrode 333 and the fixed sheet 4.

The solid lubricant of the sliding layer 35 may be, for example, molybdenum disulfide, which is a molybdenum compound. Although not shown in the figures, molybdenum disulfide has a layered crystal structure, and each layer has such a structure that a molybdenum layer is interposed between sulfur layers on opposite sides. While the bond between Mo atoms and S atoms in each layer is strong, the bond between S atoms, which connects adjacent layers with each other, is very weak, and an interlayer sliding occurs easily at the bonding layer between S atoms. Therefore, it is possible to realize a desirable relative displacement between the piezoelectric sheet 5 and the fixed sheet 4 by providing the sliding layer 35 of molybdenum disulfide in a layered crystal structure parallel to the interlayer boundary plane between the control electrode 332 and the fixed sheet 4 and between the ground electrode 333 and the fixed sheet 4.

Alternatively, the solid lubricant may be graphite. Graphite also has a layered crystal structure, and while carbons are coupled together by a strong covalent bond in each layer, adjacent layers are bonded together by a weak van der Waals force. Therefore, an interlayer sliding occurs easily. Thus, it is possible to realize a desirable relative displacement between the piezoelectric sheet 5 and the fixed sheet 4, as with molybdenum disulfide described above.

Moreover, the solid lubricant may be a silicon nitride, particularly β-silicon nitride, or hexagonal boron nitride, which can withstand the sintering temperature of the piezoelectric member, for example. Alternatively, the sliding layer 35 may be a slit that can maintain its shape withstanding the temperature at which the piezoelectric member is sintered. Moreover, the sliding layer 35 may be a flexible material that can withstand the temperature at which the piezoelectric member is sintered. The flexible material has such a structure that it is less susceptible to a displacement constraint in the piezoelectric constant d₃₁ direction of the piezoelectric sheet 5.

The control electrode 332, the ground electrode 333 and the sliding layer 35 described above can each be formed by, for example, a printing method on the surface of the piezoelectric sheet 5 or the fixed sheet 4. Alternatively, one may disperse nano particles of materials that satisfy various functions in a predetermined solvent, apply the dispersion liquid by an ink jet method, and then pattern the product after the baking step.

Note that while electrodes, etc., are exaggerated in FIG. 2 to appear thicker for the sake of illustration, the thicknesses of the control electrode 332, the ground electrode 333 and the sliding layer 35 are each set to 50 nm. The thicknesses of these layers may be set to be 20 nm or more and 100 nm or less. A layer less than 20 nm is likely to have a defect in the resulting metal film, or the like, as an electrode, and a layer exceeding 100 nm results in a large distortion of the piezoelectric actuator 2 as a whole due to the difference in thickness in the X direction between the driven end surface side on which electrodes, etc., are provided and the electrode end surface P1 side. With the thickness of the electrode, or the like, being about 50 nm, when the piezoelectric sheet 5 and the fixed sheet 4 formed by flexible green sheets are pressed against each other in the lamination direction, portions of the green sheets that are in contact with these electrode portions deform, thus making it possible to generally achieve the intended thickness.

Where graphite is used as the constituent material of the sliding layers 35, the sliding layers 35 can function also as the control electrode 332 and/or the ground electrode 333 since graphite is conductive. With this configuration, where the resistance value of the graphite formed in a thin layer has a problem in terms of the CR time constant (i.e., a factor that inhibits the responsiveness as a piezoelectric member), the area shown as the sliding layer 35 in FIG. 2 may be formed by graphite (as an alternative to the control electrodes 332) with the other portions (i.e., the connection lines 335) being a patterned metal.

As described above, the piezoelectric actuator 2 can be expressed in short as follows: a piezoelectric actuator including the piezoelectric sheet 5, first and second electrodes (the control electrode 332 and the ground electrode 333) provided respectively on the front and reverse surfaces of the piezoelectric sheet 5, and fixed portions (the fixed sheets 4, 4) sandwiching and supporting the piezoelectric sheet 5 and the first and second electrodes from opposite sides, wherein the sliding layers 35, 35 are provided between the fixed portion and the first and second electrodes for allowing for a relative displacement between the piezoelectric sheet 5 and the fixed portions.

Alternatively, the piezoelectric actuator 2 may also be expressed as follows: a piezoelectric actuator including the piezoelectric sheet 5, a first electrode (the control electrode 332) provided on one surface side of the piezoelectric sheet 5, a second electrode (the ground electrode 333) provided on the other surface side of the piezoelectric sheet 5, the sliding layer 35 provided on the outer side of the first electrode, the sliding layer 35 provided on the outer side of the second electrode, and fixed portions (the fixed sheets 4, 4) sandwiching and supporting the piezoelectric sheet 5, the first and second electrodes and the sliding layers 35, 35 from opposite sides.

In the piezoelectric actuator 2, the piezoelectric sheet 5 and the fixed portions are displaced with respect to each other via the sliding layers 35 along the boundary plane therebetween, i.e., in a direction perpendicular to the lamination direction of the piezoelectric sheet 5 and the fixed portions.

The piezoelectric actuator 2 has its driven end surface attached to the pressure chamber partitioning members 9. The pressure chamber partitioning members 9 partition the pressure chambers 7 together with the nozzle plate 45 and the piezoelectric actuator 2. A plurality of pressure chambers 7 are arranged in the X direction, each corresponding to one displaced end surface 3a of the piezoelectric sheet 5 of the piezoelectric actuator 2 (see also FIG. 3). Adjacent pressure chambers 7 are partitioned from each other by a partition (the pressure chamber partitioning member 9). With such a configuration, the pressure caused by the displacement of the displaced end surface 3a of each piezoelectric sheet 5 does not influence adjacent pressure chambers 7.

A cover layer 36 is present between the pressure chamber 7 and the driven end surface of the piezoelectric actuator 2. Note that the cover layer 36 may not be shown in figures other than FIG. 2. The cover layer 36 is formed by a predetermined viscoelastic member, and the upper surface of the pressure chamber 7 is defined, in terms of the structure, by the cover layer 36. The cover layer 36 deforms so as to allow for the displacement of the displaced end surface 3a of each piezoelectric element portion 2b, while preventing, by its damper effect, the piezoelectric element portion 2b from vibrating when it is displaced. As a result, it is possible to increase the speed at which the head unit 1 is driven. Note that in view of the corrosion resistance to the liquid loaded in the pressure chamber 7, the viscoelastic member may be formed by, for example, a solvent-resistant rubber or a water-resistant paraxylene resin film, etc.

Referring to FIGS. 3-6, the internal structure of the head unit 1 will now be described in detail. FIG. 3 is a perspective view of a main part showing the internal structure of the head unit 1. For the sake of ease of understanding, FIG. 3 only shows a single piezoelectric sheet 5, i.e., a single piezoelectric element portion 2b, among a plurality of piezoelectric sheets 5 and fixed sheets 4 of the piezoelectric actuator 2 (the control electrode 332, the ground electrode 333, the sliding layer 35, etc., are omitted). FIG. 4A is a cross-sectional view of the head unit 1 for the Y′ direction, and FIG. 4B shows a part of FIG. 4A on an enlarged scale.

As shown in FIGS. 3 and 4, the piezoelectric element portions 2b oppose the nozzles 12 via the pressure chambers 7. In FIG. 4, reference numeral 15 denotes a supply passageway and 16 a discharge passageway, and they extend in the X direction between two nozzle rows 21 adjacent to each other in the Y′ direction so as to run along the nozzle rows 21. The supply passageway 15 and the discharge passageway 16 are a so-called “common passageway” provided commonly among a plurality of pressure chambers 7, and the common passageway runs through the piezoelectric sheet 5 and the fixed sheet 4 laminated together in the lamination direction. The common passageways may be formed by forming depressions in advance in the piezoelectric sheets 5 and the fixed sheets 4 before the piezoelectric sheets 5 and the fixed sheets 4 are laminated together, or the common passageways may be formed by performing a cutting process after laminating together, and sintering, the piezoelectric sheets 5 and the fixed sheets 4.

An aperture plate 17 including a plurality of groove-shaped aperture holes 17a provided therein is attached to the supply passageway 15 and the discharge passageway 16. The aperture plate 17 is provided for making uniform the liquid supply condition among the pressure chambers 7. Each pressure chamber 7 communicates with the aperture hole 17a via a supply port 13, and communicates with the aperture hole 17a via a discharge port 14. Therefore, the liquid 23 passing from the supply passageway 15 through the aperture hole 17a flows into the pressure chamber 7 via the supply port 13. The liquid flowing out of the discharge port 14 of each pressure chamber 7 reaches the discharge passageway 16 via the aperture hole 17a.

FIG. 5 is a configuration diagram of the piezoelectric actuator 2 in the head unit 1 as viewed from the side of the nozzle plate 45, with the nozzle plate 45 and the pressure chamber partitioning members 9 removed, wherein FIG. 5 virtually shows the nozzles 12 and the pressure chamber partitioning members 9. As already described above, the piezoelectric actuator 2 is produced by a green sheet method in which the piezoelectric sheets 5, the fixed sheets 4, the control electrodes 332, the ground electrodes 333 and the sliding layers 35 are laminated together and sintered. The polarization process is performed, after sintering, by applying a predetermined polarization process voltage to the control electrodes 332, thereby providing the piezoelectric element portions 2b that are polarized in the arrow directions (polarization directions) shown in FIG. 2.

In this embodiment, due to the limitation on the number of green sheets laminated, four piezoelectric sheets 5 are laminated together to produce an actuator block 18, and a plurality of actuator blocks 18 are arranged in the X direction to thereby realize the head unit 1 having a resolution of 1200 dpi as a whole, as shown in FIG. 1B. As described above, the head unit 1 has a piezoelectric actuator obtained by laminating together, into a block, a plurality of laminates via the fixed portions (the fixed sheets 4), wherein the laminates are obtained by laminating together the piezoelectric sheets 5, the first and second electrodes (the control electrodes 332 and the ground electrodes 333) and the sliding layers 35, 35 (see FIG. 2).

As shown in FIG. 5, the lamination direction of the piezoelectric sheets 5 and the fixed sheets 4 coincides with the X′ direction in the X′-Y′ coordinate system shown in FIG. 1B. That is, they are laminated in a direction tilted by the angle θ with respect to the direction (the X direction) in which the nozzle row 21 is arranged. More accurately, the actuator blocks 18 formed by successively laminating together the piezoelectric sheets 5 and the fixed sheets 4 are arranged while being tilted by the angle θ with respect to the X direction. The angle θ is set so that the piezoelectric element portions 2b sandwiched between the control electrodes 332 and the ground electrodes 333 (see FIG. 2, FIG. 4) and the nozzles 12 are shifted from one another by the nozzle density specification value (e.g., 1200 dpi). Note that the direction of the supply passageways 15 and the discharge passageways 16 (see FIG. 4, FIG. 6) is set to be the X direction.

Note that while the number of nozzles in the X′ direction included in one actuator block 18 is herein set to be four, the number corresponds to the number of green sheets that can be laminated together at once, and the number of sheets to be laminated may be determined appropriately. This determines the number of nozzles in the X′ direction included in one actuator block 18. While four nozzle rows 21 are provided in the Y′ direction, the number of rows is not limited to four, but may be set to any number. The length of the piezoelectric sheet 5 in the Y′ direction essentially determines the number of nozzles in the Y′ direction, and limitations on the resolution in the X direction can be eliminated, in theory, by adjusting the length of the sheet 5 and the angle θ.

The opposite end portions of each actuator block 18 in the X′ direction are formed by fixed sheets 4a, and a plurality of actuator blocks 18 are coupled together (i.e., into an integral piezoelectric actuator) by bonding the fixed sheets 4a together. The thickness of the fixed sheet 4a is set to be less than or equal to ½ the thickness of other fixed sheets 4 so as to accommodate the nozzle pitch. This ensures that the nozzle pitch, i.e., the pitch of the piezoelectric sheets 5 in other words, is constant over a plurality of actuator blocks 18.

FIG. 6 is a schematic configuration diagram showing a system in which a liquid circulates in the head unit 1. The liquid 23 from a liquid tank 22 passes through the supply passageway 15 via a supply pump 24, and reaches the pressure chamber 7 via the aperture hole 17a provided in the aperture plate 17 and the supply port 13. Then, the liquid 23 from the pressure chamber 7 returns to the liquid tank 22 via the discharge port 14, the aperture hole 17a, the discharge passageway 16, a filter 26 and a discharge pump 25. Thus, the liquid 23 is always circulating in the head unit 1 at least during the printing operation. Such a liquid circulation system is capable of removing foreign substances present in the pressure chamber 7, etc., by means of the filter 26 provided in the circulation path. There is also an advantage that even if bubbles are generated, bubbles can be removed from inside the pressure chamber 7 by the circulation of the liquid, thereby improving the liquid discharging stability.

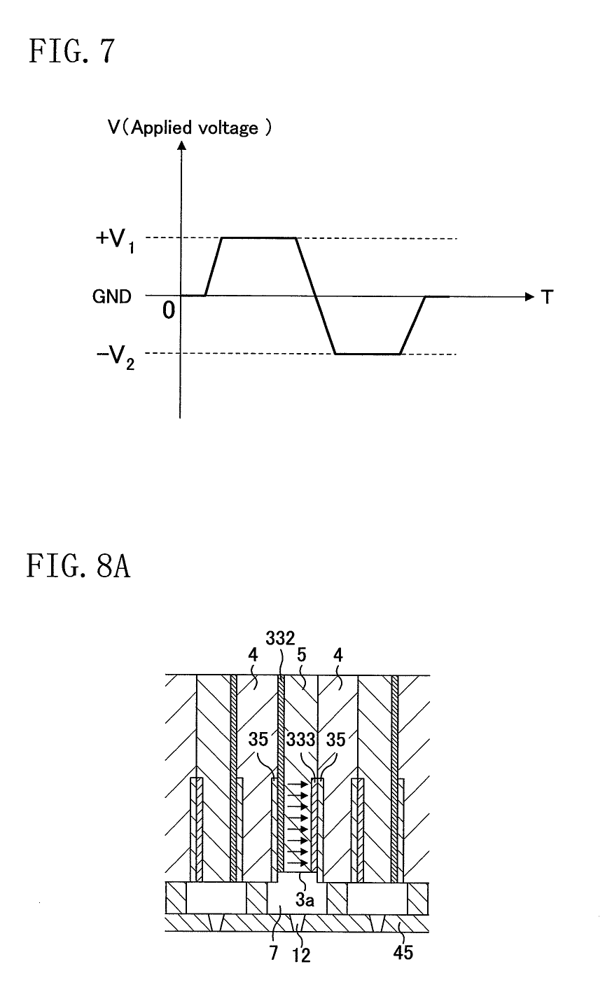

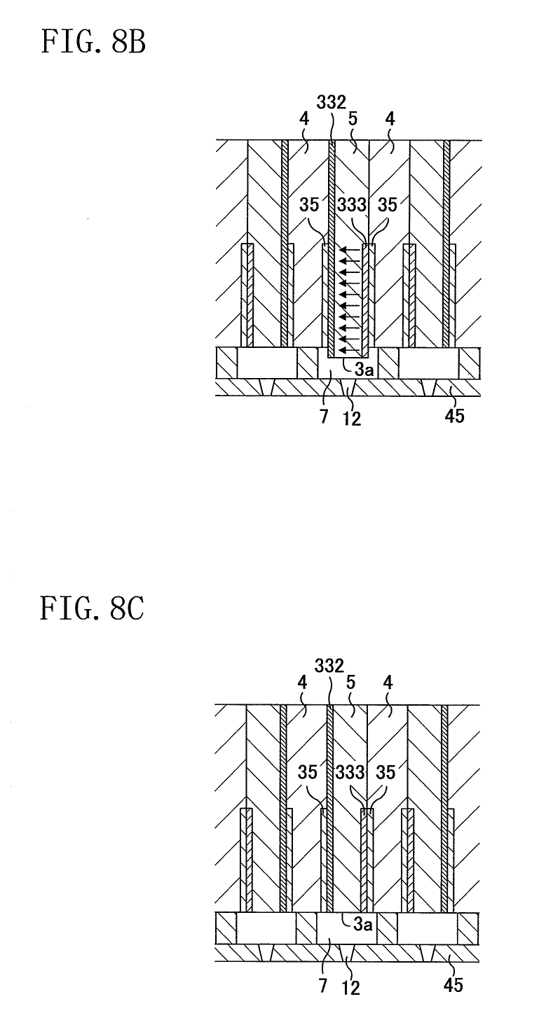

FIG. 7 illustrates the waveform of a driving voltage applied to the piezoelectric actuator 2 in the head unit 1 of the present embodiment. The driving voltage waveform is formed by a combination of a positive voltage of +V₁, a negative voltage of −V₂ and the ground potential (GND). FIG. 8A illustrates a state of the piezoelectric actuator 2 when a positive voltage (+V₁) is applied to the control electrode 332, FIG. 8B illustrates a state of the piezoelectric actuator 2 when a negative voltage (−V₂) is applied to the control electrode 332, and FIG. 8C illustrates a state of the piezoelectric actuator 2 when the ground potential is applied to the control electrode 332. Referring to FIGS. 7 and 8, the behavior of the piezoelectric actuator 2 when a driving voltage waveform is applied from a driving circuit (not shown) to the control electrode 332 will now be described.

As shown in FIG. 8A, as a voltage of +V₁ is applied to the control electrode 332, an electric field is applied across the piezoelectric sheet 5 in the direction from the control electrode 332 to the ground electrode 333 (i.e., the polarization direction). As a result, the piezoelectric sheet 5 contracts in the piezoelectric constant d₃₁ direction. Then, the displaced end surface 3a of the piezoelectric actuator 2 is displaced upward, thereby increasing the volume of the pressure chamber 7. Thus, the liquid 23 is loaded into the pressure chamber 7.

Then, as shown in FIG. 8B, as a voltage of −V₂ is applied to the control electrode 332, an electric field is applied across the piezoelectric sheet 5 in the direction from the ground electrode 333 to the control electrode 332 (i.e., the opposite direction to the polarization direction). As a result, the piezoelectric sheet 5 expands in the piezoelectric constant d₃₁ direction. Then, the displaced end surface 3a is displaced downward, thereby decreasing the volume of the pressure chamber 7. Thus, a pressure is applied to the liquid 23 in the pressure chamber 7, thereby pushing out the liquid 23 in the pressure chamber 7 to the outside through the nozzle 12.

Then, as shown in FIG. 8C, as a voltage of the ground potential (GND) is applied to the control electrode 332, the potential difference between the control electrode 332 and the ground electrode 333 disappears, and the displaced end surface 3a returns to the reference position. This cuts off the droplet being discharged, thereby resulting in a predetermined amount of the liquid 23 discharged through the nozzle 12.

As described above, in the piezoelectric actuator 2, the fixed sheets 4 are laminated on the piezoelectric sheet 5 including the piezoelectric element portion 2b, and the first electrode (the control electrode 332) and the second electrode (the ground electrode 333) are arranged in parallel to the sliding layers 35. Therefore, it is possible to ensure the rigidity of the piezoelectric element portion even if the thickness of the piezoelectric element portion is reduced by reducing the thickness of the piezoelectric sheet 5 or the height of the piezoelectric element portion 2b is increased by increasing the height L of the electrode. As a result, it is possible to increase the resolution by decreasing the nozzle pitch and to increase the amount of displacement of the piezoelectric element portion 2b so that a high-viscosity liquid can be discharged, while ensuring a sufficient rigidity of the piezoelectric element portion 2b.

The provision of the sliding layers 35, or the like, between the piezoelectric sheet 5 and the fixed sheets 4 reduces the energy loss upon displacement of the piezoelectric sheet 5 and improves the conversion efficiency of the piezoelectric actuator 2.

### Embodiment 2

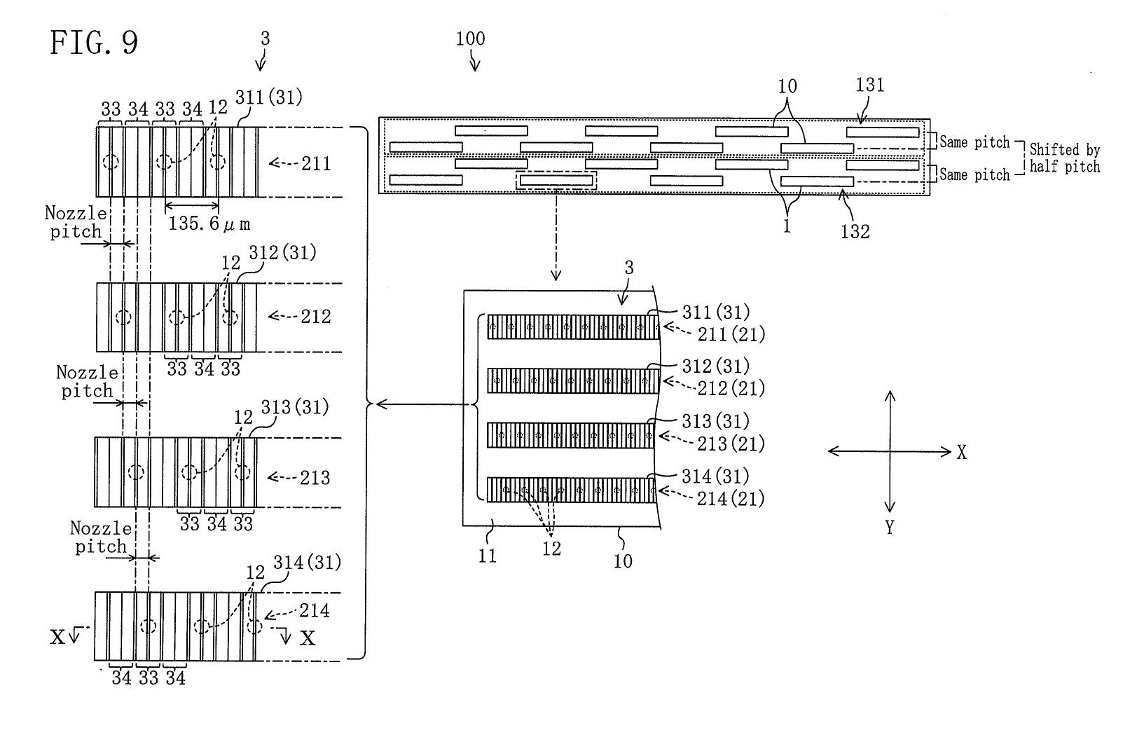

FIG. 9 shows a configuration of the line head 100 of Embodiment 2. As shown in the upper center diagram of FIG. 9, the line head 100 includes a plurality of head units 10 therein. The plurality of head units 10 are arranged in a staggered pattern with a predetermined regular interval therebetween in the primary scanning direction (the X direction), thereby forming head rows 131 and 132, wherein the head rows 131 and 132 are arranged in two rows (the first head row 131 and the second head row 132) in the sub-scanning direction (the Y direction).

As shown in the lower center diagram of FIG. 9, each head unit 10 provided in the line head 100 includes nozzle rows 21 on the nozzle surface 11, each including a plurality of nozzles 12 arranged with a predetermined regular interval therebetween in the X direction, and the nozzle rows 21 are arranged in four rows in the Y direction. Note that in the following description, the nozzle rows 21 may be referred to as a first nozzle row 211, a second nozzle row 212, a third nozzle row 213 and a fourth nozzle row 214, in this order from the uppermost nozzle row 21 to the lowermost nozzle row 21. Each head unit 10 also includes a piezoelectric actuator 3 including piezoelectric element rows 31 (311-314) corresponding to the nozzle rows 21, as will later be described in detail.

As shown in an enlarged scale in the left diagram of FIG. 9, in each nozzle row 21, the nozzles 12 are arranged at a regular interval in the Y direction, and the nozzles 12 are arranged while being shifted from one another in the X direction by a predetermined pitch between adjacent nozzle rows 21. Thus, with the head unit 10, the nozzles 12 are arranged while being shifted from one another in the Y direction and in the X direction, thereby realizing a predetermined nozzle pitch for the four nozzle rows 21 as a whole. Specifically, with the head unit 10, the nozzle pitch is set so that the resolution is 750 dpi in the X direction. Therefore, the nozzle pitch is set to 33.9 μm (=25.4 mm/750 dpi), and the interval between the nozzles 12 in each nozzle row 21 is set to be four times larger than that, i.e., 135.6 μm.

The head units 10 whose resolution is thus set to 750 dpi are arranged in a staggered pattern as described above, thereby forming the first and second head rows 131 and 132 (see the upper center diagram of FIG. 9). When the head units 10 included in each of the head rows 131 and 132 are attached to the line head 100, the head units 10 are aligned so that all the nozzle pitches are equal in the X direction and are then fixed to the line head 100.

On the other hand, the first head row 131 and the second head row 132 are arranged and fixed after being aligned in the X direction so that the nozzles 12 included therein are shifted from one another by half the pitch (i.e., ½ the nozzle pitch: 17.0 μm). Therefore, the resolution in the X direction of the line head 100 as a whole is set to be 1500 dpi, which is twice 750 dpi.

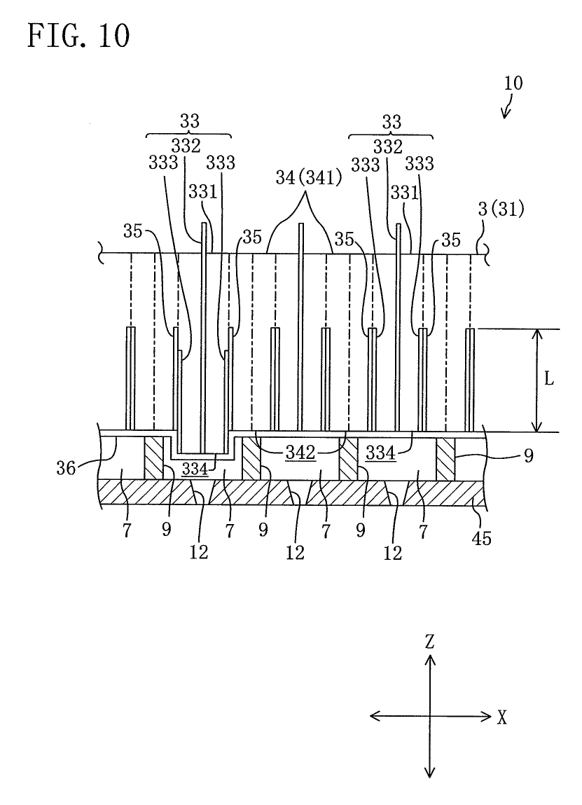

As shown in FIG. 10, etc., each head unit 10 includes the piezoelectric actuator 3, the pressure chamber partitioning member 9 and the nozzle plate 45. Note that FIG. 10 depicts the configuration of the piezoelectric actuator 3 in a schematic manner for the sake of ease of understanding, and there are portions that do not correspond to those of the configuration of the piezoelectric sheet to be described later. The configuration of the pressure chamber partitioning member 9 and the nozzle plate 45 is substantially the same as that shown in FIGS. 3 and 4, etc.

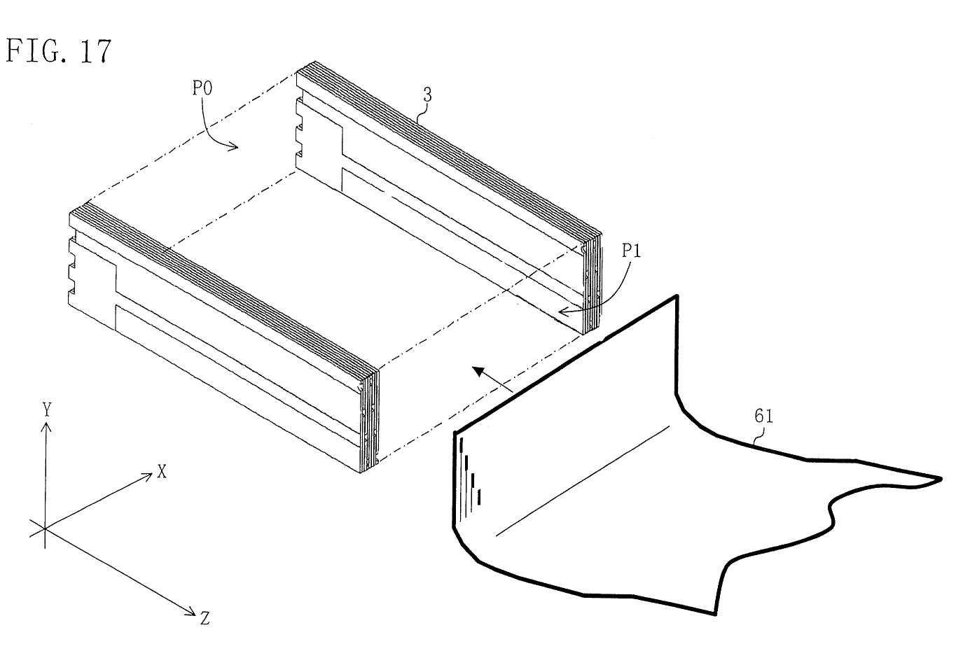

As shown in FIG. 17, for example, the piezoelectric actuator 3 is in a generally rectangular block shape, whose first end surface is the driven end surface P0 (hereinafter referred to also as “the first end surface P0” or “the driven end surface P0,” depending on whether the structure or the function is being referred to), and whose second end surface is the electrode end surface P1 (similarly, referred to also as “the second end surface P1” or “the electrode end surface P1”). Hereinafter, the piezoelectric actuator 3 may be referred to as an actuator block 3.

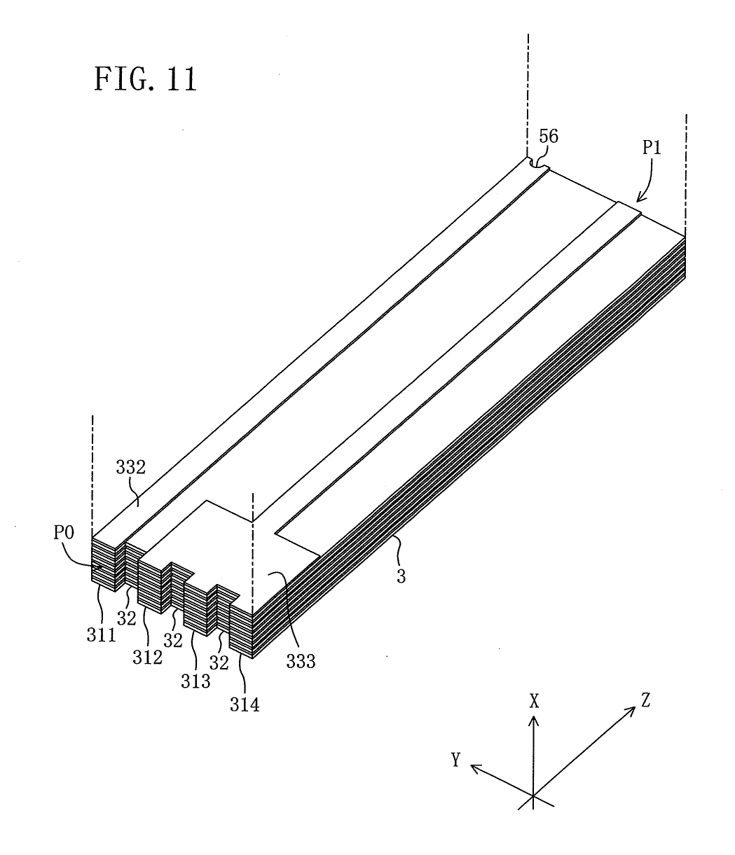

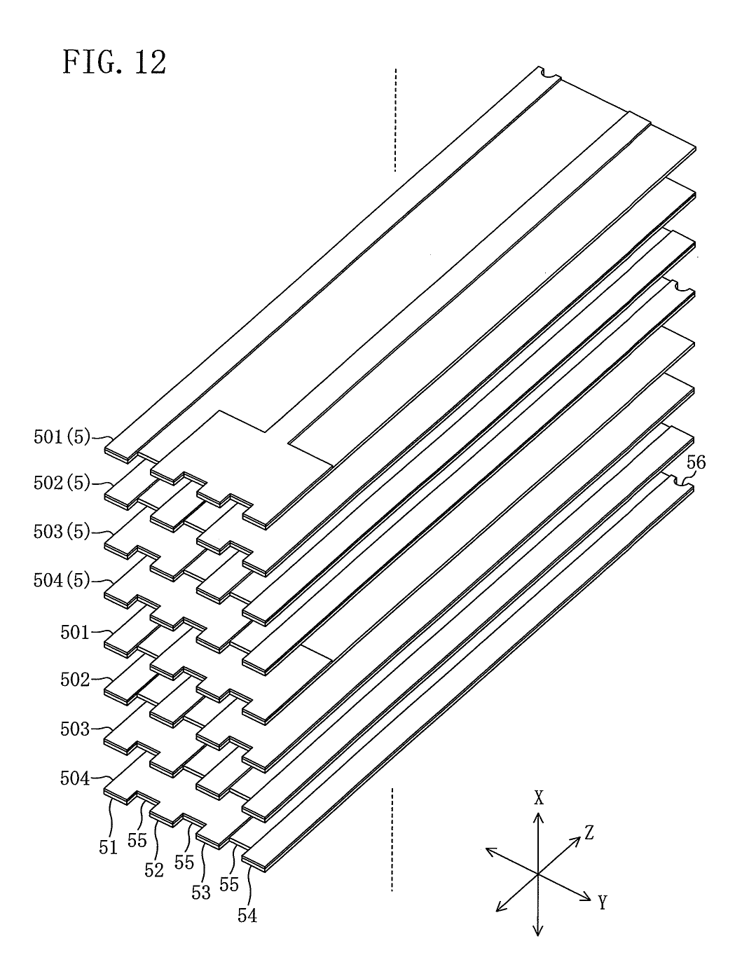

As will be later described in detail, the actuator block 3 is a laminate obtained by laminating together, in the X direction, a plurality of piezoelectric sheets 5 (see FIG. 12) with a predetermined electrode pattern formed thereon. As shown in FIG. 11, etc., the piezoelectric element rows 311-314, each extending in the X direction, are provided on the driven end surface P0 side of the actuator block 3, and the four piezoelectric element rows 311-314 are arranged in the Y direction with a predetermined regular interval therebetween. Note that a concave groove 32 is formed between adjacent piezoelectric element rows, being depressed from the driven end surface P0 and extending in the X direction. Here, the actuator block 3 will be described while assuming that there are four piezoelectric element rows 311-314, it is understood that the number of rows may be increased or decreased.

As shown in the left diagram of FIG. 9, each piezoelectric element row 31 includes a plurality of piezoelectric element portions 33 arranged in the X direction at the same interval as the nozzles 12 (four times the nozzle pitch), and fixed portions 34 arranged between the piezoelectric element portion 33 and the piezoelectric element portion 33 (more accurately, it includes the piezoelectric element portions 33 and the fixed portions 34 laminated together alternately). Moreover, between the piezoelectric element rows 31 adjacent to each other in the Y direction, the piezoelectric element portions 33 are shifted from each other by the nozzle pitch. In the X direction, i.e., the lamination direction of the piezoelectric sheets 5, each piezoelectric element portion 33 is a portion (active portion) that functions as a piezoelectric element in the presence of an applied voltage, whereas the fixed portion 34 is a portion (inactive portion) that does not function as a piezoelectric element but supports the piezoelectric element portion 33. That is, the piezoelectric actuator has a structure in which active portions and inactive portions are arranged periodically in the X direction.

On the other hand, as can be seen by referring to the left diagram of FIG. 9 and FIG. 11 (note that the left diagram of FIG. 9 only shows the first piezoelectric element row 311 to the fourth piezoelectric element row 314 of the driven end surface P0 shown in FIG. 11 and does not show the concave grooves 32), active portions (the piezoelectric element portions 33) and inactive portions (the fixed portions 34) coexist on a single piezoelectric sheet 5 in the Y direction. As will be described later, the distinction between active portions and inactive portions is determined based on the electrode pattern formed on each piezoelectric sheet 5.

As shown in FIG. 10, each piezoelectric element portion 33 includes the control electrode 332, a first piezoelectric layer 331 formed by two piezoelectric sheets 5 (see FIG. 12) arranged on opposite sides with the control electrode 332 sandwiched therebetween, and the ground electrodes 333 arranged on opposite sides of the first piezoelectric layer 331, and each fixed portion 34 includes a second piezoelectric layer 341 formed by the piezoelectric sheet 5 (see FIG. 12). From a different perspective, the relationship between the first piezoelectric layer 331 and the control electrode 332 may be rephrased as follows: the control electrode 332 is arranged at a generally central position of the first piezoelectric layer 331 in the thickness direction thereof (and on the driven end surface P0 side, or near the driven end surface P0).

That is, the piezoelectric actuator of the present embodiment can be expressed in short as follows: the piezoelectric actuator includes a first piezoelectric portion (the first piezoelectric layer 331: including two piezoelectric sheets 5 and the control electrode 332 sandwiched between the piezoelectric sheets 5) and a second piezoelectric portion (the second piezoelectric layer 341) laminated together, wherein the first piezoelectric portion and the second piezoelectric portion are relatively displaced from each other along the boundary between the first and second piezoelectric portions.

Each first piezoelectric layer 331 is polarized so that it is displaced in the d₃₁ direction. The control electrode 332 is an electrode to which a control potential for displacing the first piezoelectric layer 331 is applied, whereas the ground electrode 333 is an electrode maintained at the ground potential. As shown in FIG. 10 and FIG. 11, the control electrode 332 and the ground electrode 333 are arranged extending in the height direction perpendicular to the X direction and the Y direction.

With this configuration, by applying a predetermined voltage between the control electrode 332 and the ground electrode 333 in a predetermined piezoelectric element portion 33, the first piezoelectric layer 331 of the piezoelectric element portion 33 stretches in the direction of the interlayer boundary plane between the first piezoelectric layer 331 and the second piezoelectric layer 341 (i.e., the sliding direction). As a result, the first piezoelectric layer 331 is relatively displaced with respect to the second piezoelectric layer 341 along the interlayer boundary plane. Therefore, a displaced end surface 334 of the piezoelectric element portion 33 formed by the first piezoelectric layer 331 projects beyond a stationary end surface 342 of the fixed portion 34 formed by the second piezoelectric layer 341.

The sliding layer 35 of a solid lubricant is provided between the piezoelectric element portion 33 and the fixed portion 34 in each piezoelectric element row 31. Specifically, the sliding layer 35 is provided between the ground electrode 333 and the second piezoelectric layer 341 as shown in FIG. 10. The sliding layer 35 allows the ground electrode 333 and the second piezoelectric layer 341 to relatively slide against each other along the interlayer boundary plane, thereby reducing the frictional resistance in the relative displacement between the first piezoelectric layer 331 and the second piezoelectric layer 341 in the presence of an applied voltage described above. This improves the conversion efficiency of the piezoelectric element portion 33.

As shown in FIG. 12, the actuator block 3 is produced by laminating and sintering a large number of piezoelectric sheets 5, which are formed primarily by PZT. The large number of piezoelectric sheets 5 include a first piezoelectric sheet 501, a second piezoelectric sheet 502, a third piezoelectric sheet 503 and a fourth piezoelectric sheet 504, and the first to fourth piezoelectric sheets 501-504 are repeatedly laminated together in this order (note however that the order of lamination will be the fourth piezoelectric sheet 504, the third piezoelectric sheet 503, the second piezoelectric sheet 502 and the first piezoelectric sheet 501 in an actual manufacturing process where the lamination goes from bottom to top). As will later be described in detail, predetermined electrode patterns are printed on the surfaces of the first to fourth piezoelectric sheets 501-504, and the electrode patterns differ from each other between the first to fourth piezoelectric sheets 501-504.

The first piezoelectric layer 331 and the second piezoelectric layer 341 described above are each formed by two piezoelectric sheets 5 and 5. Therefore, the interval between the piezoelectric element portions 33 in each piezoelectric element row 31 corresponds to four piezoelectric sheets 5, which is 135.6 μm (i.e., the resolution is about 187 dpi for one nozzle row 21, and it is about 750 dpi for the four nozzle rows 21 (the first nozzle row 211 to the fourth nozzle row 214 shown in the left diagram of FIG. 9) as a whole) as described above, and thus the thickness of one piezoelectric sheet 5 is set to be a little less than about 34 μm. Note that the thickness of the piezoelectric sheet 5 is set depending on the resolution (nozzle pitch) in the X direction of the head unit 10. The thickness t of the piezoelectric sheet 5 may be appropriately set within a range of 10 μm≦t≦65 μm, for example, depending on the resolution required.

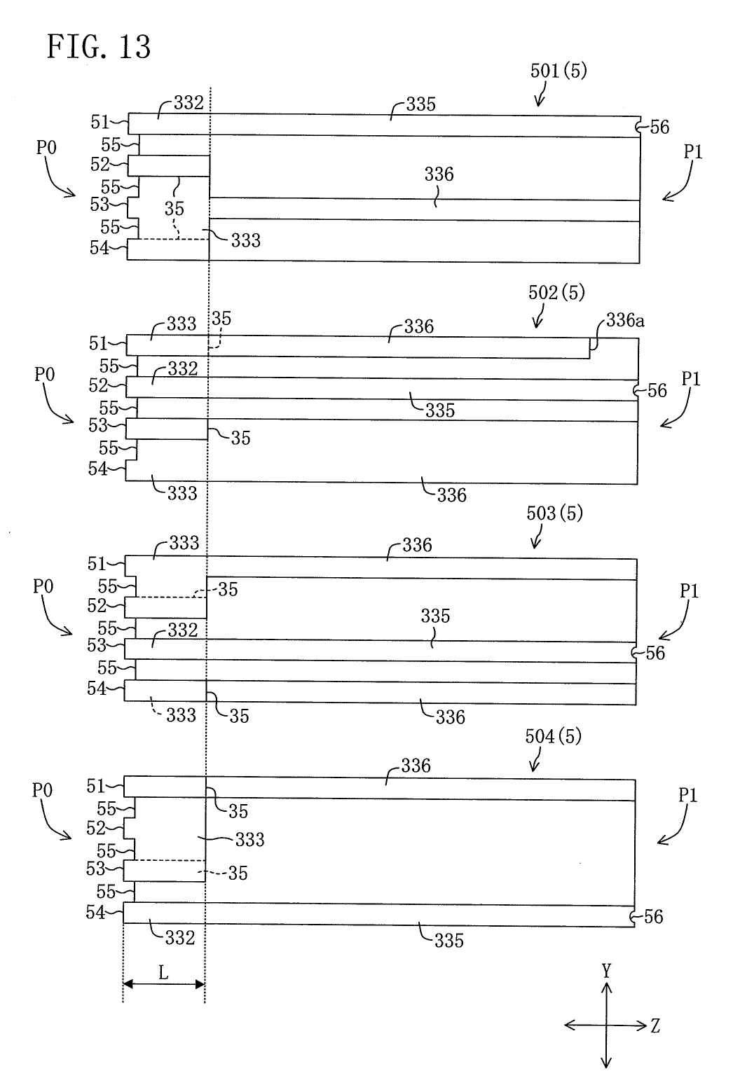

As shown in FIG. 13, the four types of piezoelectric sheets 5 have the same strip shape, wherein the first end portion P0 in the longitudinal direction is cut in advance into a convex/concave shape, while the second end portion P1 is in a flat shape. Specifically, provided at the first end portion P0 of the various piezoelectric sheets 5 are four convex portions 51, 52, 53 and 54 arranged in the Y direction at regular intervals and three concave portions 55 arranged between the convex portions. When the piezoelectric sheets 5 are laminated together to produce the piezoelectric actuator 3, the convex portions 51-54 form the piezoelectric element row 31 (see the left diagram of FIG. 9) extending in the X direction (the lamination direction of the piezoelectric sheets 5). Hereinafter, the four convex portions in the various piezoelectric sheets 5 will be referred to as the first to fourth convex portions 51-54 from top to bottom in FIG. 13 for the sake of discussion. Note that each concave portion 55 in the various piezoelectric sheets 5 forms the concave groove 32 (see FIG. 11) in the piezoelectric actuator 3. Note that as will be described later, the concave/convex portions 51-55 are used for positioning the piezoelectric sheets 5 when laminating the piezoelectric sheets 5.

On the other hand, provided at the second end portion of the various piezoelectric sheets 5 is an electrode concave portion 56 depressed in a semicircular shape inwardly from the end surface. The electrode concave portion 56 is electrically connected to the control electrode 332 through the connection electrode 335 in the various piezoelectric sheets 5, whereas it is electrically connected to a driving circuit, etc., via a bump, as will be described later. Note that a conductive material is applied also on the semicircular inner surface of the electrode concave portion 56. According to the positions of the control electrodes 332 in the Y direction being different from one another between the various piezoelectric sheets 5 as will be described later, the positions of the electrode concave portions 56 in the Y direction are also different from one another between the various piezoelectric sheets 5.

A predetermined electrode pattern is formed in advance by a printing method, as shown in FIG. 13, on the surface (one surface) of the four types of piezoelectric sheets 501-504. Alternatively, one may disperse nano particles of materials that satisfy various functions in a predetermined solvent, apply the dispersion liquid by an ink jet method, and then pattern the product after the baking step.

Specifically, in the first piezoelectric sheet 501, as shown in the uppermost diagram of FIG. 13, the control electrode 332 is formed in the first convex portion 51, and the connection electrode 335 continuous with the control electrode 332 is formed to extend to the other end of the first piezoelectric sheet 501 at a position corresponding to the first convex portion 51. Corresponding to the connection electrode 335 of the control electrode 332, the electrode concave portion 56 is formed at the other end of the first piezoelectric sheet 501. In the first piezoelectric sheet 501, the ground electrodes 333 are formed in the second to fourth convex portions 52-54, and the ground electrodes 333 are integrated together. The length of the ground electrode 333 in the height direction (the length in the left-right direction in FIG. 13) is set to a predetermined length, and this length corresponds to the length L of the ground electrode 333 described above. Then, a connection electrode 336 connected to the integrated ground electrode 333 is formed to extend to the other end of the first piezoelectric sheet 501 at a position corresponding to the third convex portion 53.

In the second piezoelectric sheet 502, as shown in the second diagram from the top of FIG. 13, the control electrode 332 is formed in the second convex portion 52, and the connection electrode 335 continuous with the control electrode 332 is formed to extend to the other end of the second piezoelectric sheet 502 at a position corresponding to the second convex portion 52. In the second piezoelectric sheet 502, the electrode concave portion 56 is formed corresponding to the connection electrode 335 connected to the control electrode 332 of the second convex portion 52. In the second piezoelectric sheet 502, the ground electrodes 333 are formed in the first, third and fourth convex portions 51, 53 and 54. The ground electrodes 333 of the third and fourth convex portions 53 and 54 are integrated together. The connection electrode 336 connected to the ground electrode 333 of the first convex portion 51 is formed to extend toward the other end of the second piezoelectric sheet 502 at a position corresponding to the first convex portion 51. The connection electrode 336 connected to the integrated ground electrode 333 of the third and fourth convex portions 53 and 54 has an increased width in the Y direction, and is formed to extend toward the other end of the second piezoelectric sheet 502 at a position corresponding to the third and fourth convex portions 53 and 54. The connection electrode 336 connected to the ground electrode 333 of the third and fourth convex portions 53 and 54 extends to the other end of the second piezoelectric sheet 502, whereas the connection electrode 336 connected to the ground electrode 333 of the first convex portion 51 does not extend to the other end of the second piezoelectric sheet 502, but an end 336a thereof is positioned inward relative to the other end of the second piezoelectric sheet 502. This is for preventing the contact and shorting between the electrode concave portion 56 of the first piezoelectric sheet 501 (the connection electrode 335 connected to the control electrode 332) and the connection electrode 336 connected to the ground electrode 333 of the second piezoelectric sheet 502, when the first piezoelectric sheet 501 and the second piezoelectric sheet 502 are laid on each other.

In the third piezoelectric sheet 503, as shown in the third diagram from the top of FIG. 13, the control electrode 332 is formed in the third convex portion 53, and the connection electrode 335 continuous with the control electrode 332 is formed to extend to the other end of the third piezoelectric sheet 503 at a position corresponding to the third convex portion 53. Then, in the third piezoelectric sheet 503, the electrode concave portion 56 is formed corresponding to the control electrode 332 of the third convex portion 53 (the connection electrode 335). In the third piezoelectric sheet 503, the ground electrodes 333 are formed in the first, second and fourth convex portions 51, 52 and 54, and the ground electrodes 333 of the first and second convex portions 51 and 52 are integrated together. The connection electrode 336 connected to the integrated ground electrode 333 of the first and second convex portions 51 and 52 is formed to extend to the other end of the third piezoelectric sheet 503 at a position corresponding to the first convex portion 51. The connection electrode 336 connected to the ground electrode 333 of the fourth convex portion 54 is formed to extend to the other end of the third piezoelectric sheet 503 at a position corresponding to the fourth convex portion 54.

In the fourth piezoelectric sheet 504, as shown in the lowermost diagram of FIG. 13, the control electrode 332 is formed in the fourth convex portion 54. The connection electrode 335 continuous with the control electrode 332 is formed to extend to the other end of the fourth piezoelectric sheet 504 at a position corresponding to the fourth convex portion 54, and the electrode concave portion 56 is formed corresponding to the connection electrode 335. In the fourth piezoelectric sheet 504, the ground electrodes 333 are formed in the first to third convex portions 51-53, and they are integrated together. Then, the connection electrode 336 connected to the integrated ground electrode 333 is formed to extend to the other end of the fourth piezoelectric sheet 504 at a position corresponding to the first convex portion 51.

The sliding layers 35 are formed in advance by printing a solid lubricant in the first to fourth piezoelectric sheets 501-504.

Specifically, in the first piezoelectric sheet 501, the sliding layer 35 is formed in the second convex portion 52 and in the fourth convex portion 54. The sliding layer 35 of the second convex portion 52 is formed on the upper surface of the ground electrode 333, whereas the sliding layer 35 of the fourth convex portion 54 is formed on the lower surface of the ground electrode 333 (between the first piezoelectric sheet 501 and the ground electrode 333).

In the second piezoelectric sheet 502, the sliding layer 35 is formed in the first convex portion 51 and in the third convex portion 53, and the sliding layer 35 of the first convex portion 51 is formed on the lower surface of the ground electrode 333 (between the second piezoelectric sheet 502 and the ground electrode 333), whereas the sliding layer 35 of the third convex portion 53 is formed on the upper surface of the ground electrode 333.

In the third piezoelectric sheet 503, the sliding layer 35 is formed in the second convex portion 52 and in the fourth convex portion 54, and the sliding layer 35 of the second convex portion 52 is formed on the lower surface of the ground electrode 333 (between the third piezoelectric sheet 503 and the ground electrode 333), whereas the sliding layer 35 of the fourth convex portion 54 is formed on the upper surface of the ground electrode 333.

In the fourth piezoelectric sheet 504, the sliding layer 35 is formed in the first convex portion 51 and in the third convex portion 53, and the sliding layer 35 of the first convex portion 51 is formed on the upper surface of the ground electrode 333, whereas the sliding layer 35 of the third convex portion 53 is formed on the lower surface of the ground electrode 333 (between the fourth piezoelectric sheet 504 and the ground electrode 333).

Thus, in the first to fourth piezoelectric sheets 501-504, the position of the control electrode 332 and the ground electrode 333 and the position of the sliding layer 35 are successively moved around through the first convex portion 51 to the fourth convex portion 54. Therefore, when the first to fourth piezoelectric sheets 501-504 are laminated together to produce the actuator block 3, the piezoelectric element portion 33 in the first piezoelectric element row 311 is formed by the first and second piezoelectric sheets 501 and 502, the piezoelectric element portion 33 in the second piezoelectric element row 312 is formed by the second and third piezoelectric sheets 502 and 503, the piezoelectric element portion 33 in the third piezoelectric element row 313 is formed by the third and fourth piezoelectric sheets 503 and 504, and the piezoelectric element portion 33 in the fourth piezoelectric element row 314 is formed by the fourth and first piezoelectric sheets 504 and 501. Then, in the actuator block 3, the positions of the piezoelectric element portions 33 are shifted from one another in the X direction by one piezoelectric sheet through the piezoelectric element rows 311-314 adjacent to one another in the Y direction (see the left diagram of FIG. 9).

This when generalized means that in the Y direction, the piezoelectric element portion 33 in the 4N+1^{th} (where N is an integer greater than or equal to 0) piezoelectric element row 31 (311) is formed by the first piezoelectric sheet 501 and the second piezoelectric sheet 502, the piezoelectric element portion 33 in the 4N+2^{th} piezoelectric element row 31 (312) is formed by the second piezoelectric sheet 502 and the third piezoelectric sheet 503, the piezoelectric element portion 33 in the 4N+3^{th} piezoelectric element row 31 (313) is formed by the third piezoelectric sheet 503 and the fourth piezoelectric sheet 504, and the piezoelectric element portion 33 in the 4N+4^{th} piezoelectric element row 31 (314) is formed by the fourth piezoelectric sheet 504 and the first piezoelectric sheet 501.

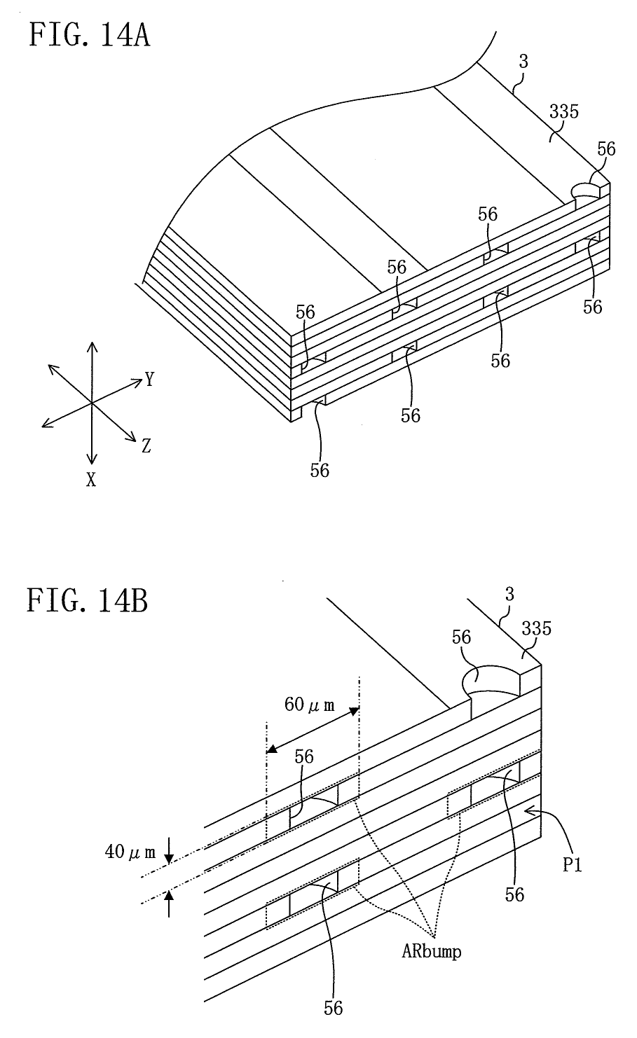

On the electrode end surface P1 side of the actuator block 3, the electrode concave portions 56 formed in the various piezoelectric sheets 501-504 are inwardly depressed from the electrode end surface P1, as shown in FIGS. 14A and 14B. Since a conductive material is applied on the inner surface of the electrode concave portions 56, as described above, each electrode concave portion 56 forms a connection electrode exposed on the electrode end surface P1. As with the piezoelectric element portions 33, the positions of the electrode concave portions 56 are shifted from one another in the X direction by one piezoelectric sheet 5 through the piezoelectric element rows 311-314 adjacent to one another in the Y direction.

Note that the electrode patterns and the positions at which the sliding layers 35 are formed shown in FIG. 13 are an example, and the electrode patterns and the positions at which the sliding layers 35 are formed may be changed as necessary. Instead of printing on only one side of the various piezoelectric sheets 5, printing may be done on both sides of the various piezoelectric sheets 5. While the control electrodes 332 and the ground electrodes 333 are exaggerated to appear thicker in FIG. 12, etc., for the sake of discussion, the thicknesses of the control electrodes 332 and the ground electrodes 333 are each set to be 50 nm in the present embodiment. These thicknesses may be set to be 20 nm or more and 100 nm or less as described above.

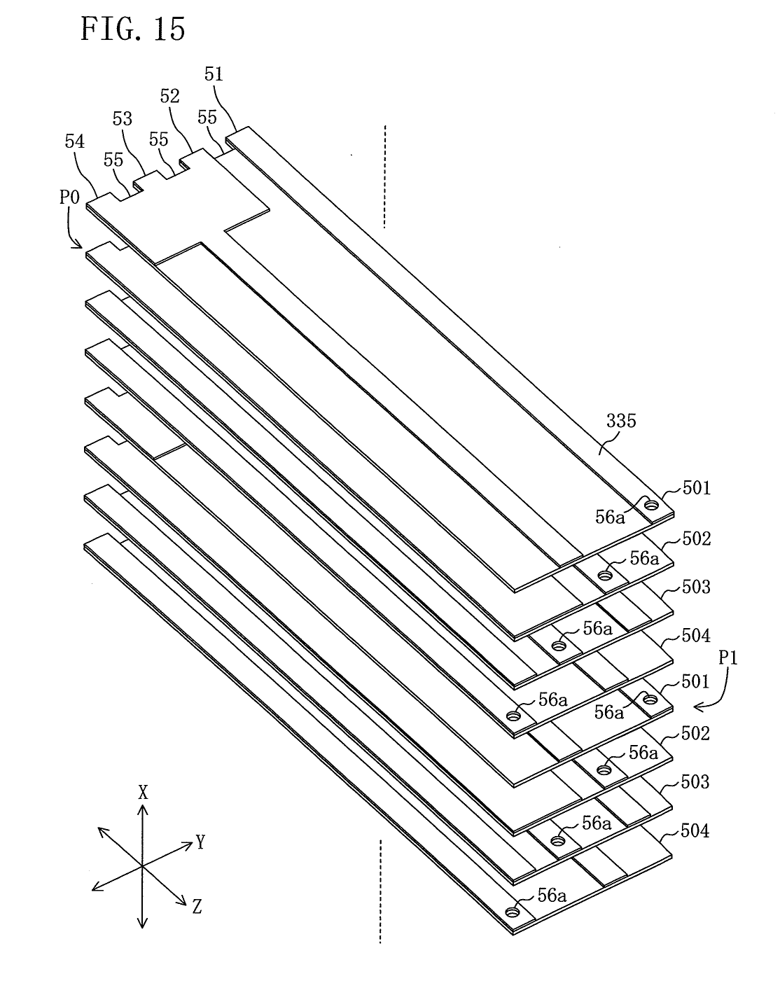

Next, the manufacturing process of the piezoelectric actuator 3 will be described. First, there are provided a large number of green sheets cut out into a predetermined rectangular shape. As shown in FIG. 15, the green sheets are provided with the concave/convex portions 51-55 formed at the first end portion P0 in the longitudinal direction, and with circular through holes 56a at positions corresponding to the connection electrodes 335 on the second end portion P1 side. Note that as will be described later, since the second end portion of each green sheet will be cut off, the length of the green sheet is set to be slightly larger than the height of the piezoelectric actuator 3.

Then, a conductive material is printed in a predetermined pattern on the surface of each green sheet, thereby forming the control electrodes 332, the ground electrodes 333 and the connection electrodes 335 and 336 as shown in the various diagrams of FIG. 13. The printing is done so that the conductive material is introduced also to the inner surfaces of the through holes 56a. That is, the metal material is applied twice, for example, in portions corresponding to the through hole 56a, or where one employs an ink jet method using an ink obtained by dispersing nano particles in a predetermined solvent, the amount of ink supplied is increased for the areas of the through holes 56a (e.g., by increasing the amount of liquid per drop or by increasing the number of times the ink is discharged as compared with those for normal areas).

Before/after the formation of the electrodes, a solid lubricant is printed at predetermined positions on each green sheet, thereby forming the sliding layers 35 on the upper surface and the lower surface of predetermined ground electrodes 333. Thus, a predetermined number of each of the first to fourth piezoelectric sheets 501-504 are produced.

As shown in FIG. 15, the produced piezoelectric sheets 501-504 are laminated repeatedly in the order of first, second, third and fourth. When the piezoelectric sheets 501-504 are laminated together, the concave/convex portions 51-55 formed at the first end portion P0 in the longitudinal direction may be used for the positioning of the sheets.

After a predetermined number of piezoelectric sheets 501-504 are laminated together to obtain a block-shaped laminate, the laminate is compressed in the lamination direction so that the height in the lamination direction becomes equal to a predetermined height. Thus, it is possible to realize a generally equal thickness among the thicknesses 501-504 of the piezoelectric sheets. This realizes a uniform size among the piezoelectric element portions 33 in the first to fourth piezoelectric element rows 311-314, and equalizes the pitch of the piezoelectric element portions 33 (see FIG. 10). This is advantageous for the alignment of the head units 10.

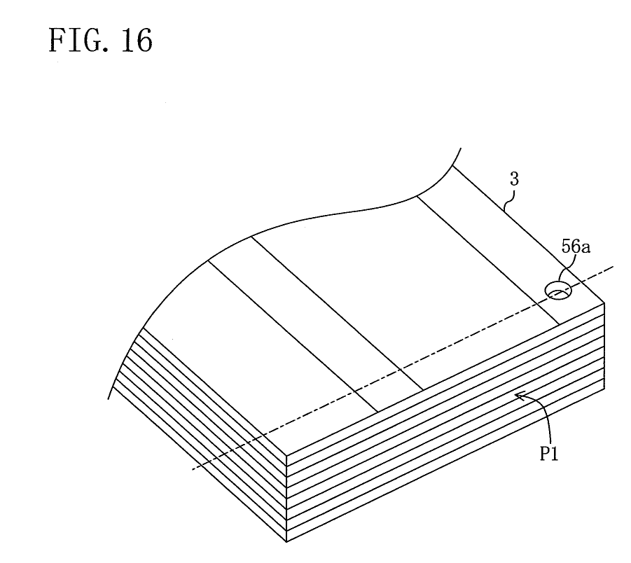

Then, the laminate is sintered into a block-shaped piezoelectric actuator 3. Then, as indicated by a one-dot-chain line in FIG. 16, the second end portion P1 side of the piezoelectric actuator 3 is cut off at a position that passes through the center of the through hole 56a. Thus, portions of the through holes 56a are inwardly depressed on the electrode end surface, so that the electrode concave portions 56 with a conductive material applied on the semicircular inner surfaces thereof are exposed on the electrode end surface as shown in FIG. 14.

In the first end portion P0 of the piezoelectric actuator 3, the cutting process (grooving process) is performed in the X direction at positions of the three concave grooves 32 to thereby finish the shapes of the first to fourth piezoelectric element rows 311-314 extending in the lamination direction (the X direction), as shown in FIG. 11. That is, the convex portions 51-54 (see FIGS. 13 and 15) of the piezoelectric sheets 501-504 expand as the laminate is compressed in the lamination direction as described above, and the widths of the piezoelectric element rows 311-314 in the piezoelectric actuator 3 in the Y direction will, as they are, vary in the X direction. However, by performing the cutting process after sintering the laminate, the widths of the first to fourth piezoelectric element rows 311-314 in the Y direction can be made equal to one another and constant in the X direction. With this manufacturing method, the positions of the piezoelectric element portions 33 in the piezoelectric actuator 3 can be set precisely, and it is possible to easily make the piezoelectric element portions 33 correspond to the positions of the pressure chambers 7 in the head unit 10.

Then, finally, a polarization process is performed (a predetermined voltage is applied to the control electrode 332 and the ground electrode 333 in advance to apply an electric field of a predetermined direction) so that the piezoelectric element portions 33 (the first piezoelectric layer 331) are displaced in the d₃₁ direction, thereby completing the fabrication of the block-shaped piezoelectric actuator 3.

Note that the concave/convex portions 51-55 are herein formed in advance in the first end portion P0 of the green sheets. However, instead of forming the concave/convex portions 51-55, the cutting process may be performed after sintering the laminate to thereby form the three concave grooves 32 in the first end portion P0 of the piezoelectric actuator 3, thus forming the first to fourth piezoelectric element rows 311-314.

The manufacturing process of the piezoelectric actuator 3 is not limited to the process of laminating together piezoelectric sheets on which predetermined electrode patterns have been formed in advance, as described above, but may be a process in which while successively laminating together piezoelectric sheets on which the through holes 56a have been formed in advance, the control electrodes 332, the ground electrodes 333, the connection electrodes 335 and 336 and the sliding layers 35 are formed on the piezoelectric sheets (laminate) by a printing method (e.g., ink jet method), for example. With such a manufacturing method, since an already-laminated piezoelectric sheet exists under the through hole 56a, it is possible to easily perform the step of burying a conductive material that is later to be an electrode exposed inside the through hole 56a described above.

The second end surface P1 of the piezoelectric actuator 3 is an electrode end surface that is flat and has a relatively large area. Then, exposed on the electrode end surface are the electrode concave portions 56, which are each connected to the control electrode 332 and are arranged in a predetermined layout. Therefore, as shown in FIG. 17, for example, a bump of Au, for example, may be formed inside the electrode concave portion 56, and a flexible printed substrate 61 may be attached to the electrode end surface P1 by an ACF, for example. The flexible printed substrate 61 is a substrate for connecting the piezoelectric actuator 3 with the driving circuit (not shown) therefor. Here, an ACF refers to a sheet-shaped material that is obtained by dispersing minute conductive particles in a film-shaped insulative resin material, and that exerts an electrical connection function in the vertical direction via conductive particles sandwiched between electrodes simultaneously with the bonding through the application of a pressure and a temperature, while exerting an insulation function in the horizontal direction. In this way, the connection of the flexible printed substrate 61 is completed at once, thus simplifying the manufacturing process. With this configuration, a driving circuit (e.g., IC chip) may be provided on the surface of the flexible printed substrate 61.

An ACF bonding requires a bump area of about 2000 μm² in view of the reliability. Since the thickness of each piezoelectric sheet in the X direction is 34 μm in the present embodiment as already described above, the bump formation area ARbump has a shape that is 60 μm in the Y direction and 40 μm in the X direction (60×40=2400>2000) so that it can be sufficiently surrounded as shown in FIG. 14B, thus ensuring a bump area necessary for an ACF. Since different (four) electrode patterns are formed on the piezoelectric sheets 5 as described above in detail with reference to FIG. 13, the electrode concave portions 56 are formed separately in the first end portion P0 of the actuator block 3. Therefore, it is sufficiently possible to form an ACF bonding bump for each electrode concave portion 56.

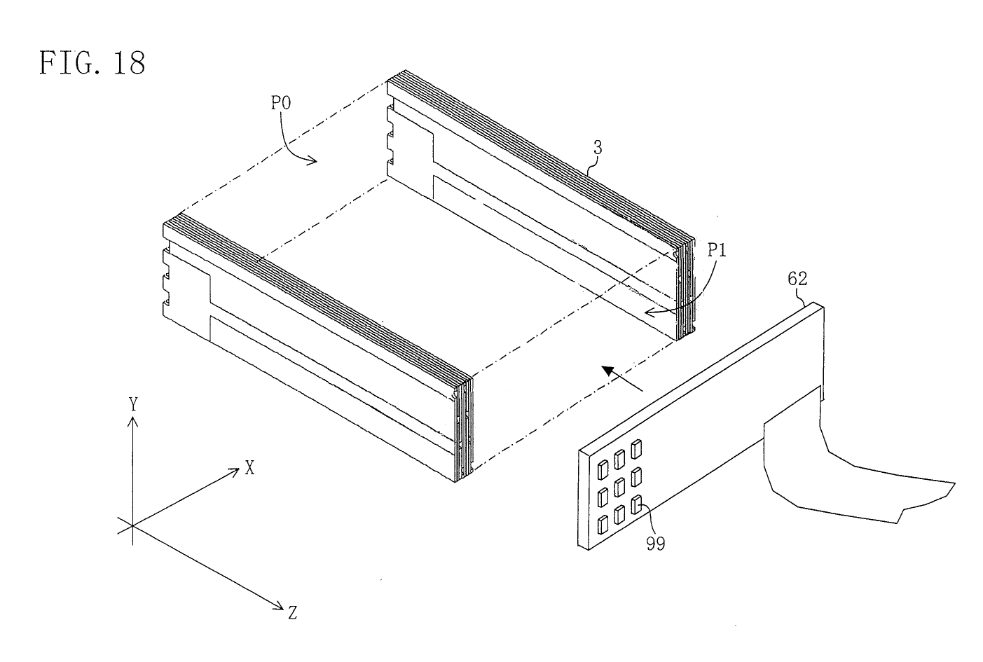

A rigid substrate 62 including an actuator driving circuit (e.g., IC chip 99) may be attached, by an ACF, for example, to the electrode end surface P1 of the piezoelectric actuator 3, as shown in FIG. 18, for example.

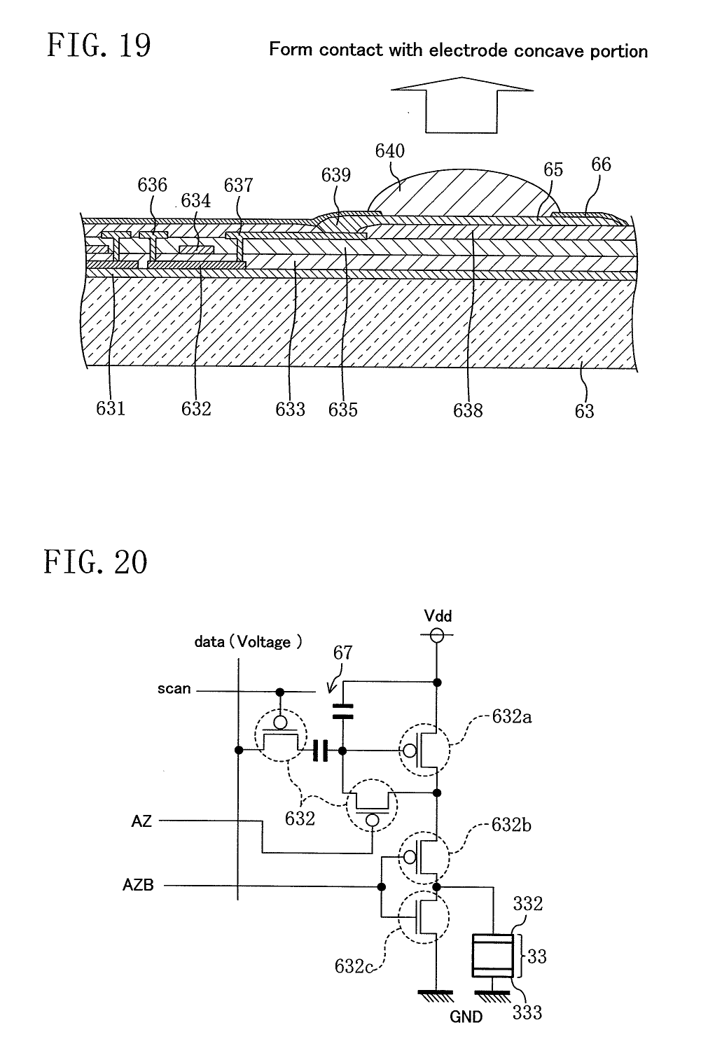

Moreover, a rigid substrate including a thin film transistor (TFT) opposing the electrode end surface of the piezoelectric actuator 3 may be attached to the electrode end surface. FIG. 19 shows a cross-sectional view of an actuator driving circuit including a TFT. In this figure, reference numeral 63 denotes a glass substrate as the rigid substrate 62. While a glass is used as the substrate herein, other materials such as ceramics may be used as long as the flatness can be ensured. Reference numeral 631 denotes a basecoat layer formed on the surface of the glass substrate 63, and is formed by laminating SiN and SiO₂ together, for example. A TFT 632 of polycrystalline silicon (polysilicon) is formed on the basecoat layer 631. In the present embodiment, the TFT 632 uses polycrystalline silicon capable of high-speed operation in terms of the carrier mobility, etc. However, amorphous silicon may be used. Although amorphous silicon is disadvantageous in terms of the design rules and the driving frequency, as compared with polycrystalline silicon, amorphous silicon is advantageous cost-wise because the manufacturing process is inexpensive.

Reference numeral 633 denotes a gate insulating layer of SiO₂, for example, which provides separation with a predetermined interval, and insulation, between the TFT 632 and a gate electrode 634 of a metal such as Mo. Reference numeral 635 denotes an intermediate layer formed by laminating SiO₂ and SiN together, for example. The intermediate layer 635 covers the gate electrode 634 and supports a source electrode 636 and a drain electrode 637 of a metal such as Al which are formed along this surface.

The source electrode 636 and the drain electrode 637 are connected to the TFT 632 via a contact hole provided in the intermediate layer 635 and the gate insulating layer 633. The TFT 632 operates as a switching transistor by applying a predetermined potential to the gate electrode 634 with a predetermined potential difference applied between the source electrode 636 and the drain electrode 637. Reference numeral 638 denotes a protection layer formed by SiN, or the like, which completely covers the source electrode 636 and includes a contact hole 639 formed over a portion of the drain electrode 637. Reference numeral 65 denotes a driving electrode formed on the protection layer 638, which in the present embodiment uses ITO (indium tin oxide) so that a conventional manufacturing process for an inorganic EL or organic EL (electroluminescent) display device, for example, can be used as it is. Other than ITO, the driving electrode 65 may use IZO (zinc-doped indium oxide), ATO (Sb-doped SnO₂), AZO (Al-doped ZnO), ZnO, SnO₂, In₂O₃, etc. While the driving electrode 65 can be formed by a vapor deposition method, or the like, it is preferably formed by a sputtering method or a CVD method (Chemical Vapor Deposition). The driving electrode 65 is connected to the drain electrode 637 through the contact hole 639.

Since the driving electrode 65 is a portion that is electrically connected to the electrode concave portion 56 of the piezoelectric actuator 3, the electric resistance value (particularly, the contact resistance) thereof is preferably controlled to be low. Therefore, it is preferred to further form (metalize) a metal film on the surface of the driving electrode 65. Note that ITO, or the like, described above is chosen in view of the ionization potential difference between materials for injecting charge (supplying more holes, electrons) into a light-emitting material of an organic EL device, but when driving a piezoelectric member, it is not necessary to consider the charge injection efficiency, and a simple ohmic contact is sufficient. Therefore, the driving electrode 65 itself may be formed by a metal, instead of ITO, or the like.

An electrode area delimiting portion 66 is formed in an area of the surface of the driving electrode 65 other than the area where a contact with the electrode concave portion 56 is formed. The electrode area delimiting portion 66 defines the area for forming a contact with the electrode concave portion 56 formed on the electrode end surface P1 of the piezoelectric actuator 3, and also serves as a protection layer for protecting the entire driving circuit formed by the TFT 632, etc. Then, a contact bump 640 is formed on the driving electrode 65, and the substrate can be attached to the electrode end surface of the piezoelectric actuator 3 via an ACF. Note that the bump 640 may be provided on the electrode concave portion 56 side as described above.

The TFTs 632 are formed on the substrate to achieve a 1:1 relationship with the piezoelectric element portions 33 of the piezoelectric actuator 3, and electrically form so-called “active matrix circuits.” Using the source electrode 636 as a positive electrode, and controlling the gate electrode 634 to a predetermined potential, a current is supplied to the piezoelectric element portion 33 via the source electrode 636, the TFT 632, the drain electrode 637 and the driving electrode 65, thereby driving the piezoelectric element portion 33.

FIG. 20 is a configuration diagram showing an example of an actuator driving circuit. The actuator driving circuit forms a constant voltage circuit 67 of a threshold-compensating type by five TFTs (two TFTs 632, a TFT 632a, a TFT 632b, a TFT 632c), wherein the constant voltage circuit 67 of one of them drives one piezoelectric element portion 33. Typically, an actuator formed by a piezoelectric member (e.g., ferroelectric member) has a large capacitance C. Therefore, with a so-called “constant current driving,” the stored charge is charged linearly over time, and the charging therefore takes a long time. This results in a decrease in the driving frequency of the actuator. In contrast, with a constant voltage driving, the charge storing is done non-linearly (in the sense that it is not proportional to the passage of time), and particularly, the initial charge storing after ON/OFF is done at a very high speed. Therefore, it is suitable for driving a piezoelectric member. The final output stage of the constant voltage circuit 67 is formed by two TFTs 632b and 632c, wherein the TFT 632b is ON when a predetermined voltage (Vdd) is applied to the piezoelectric element portion 33 and the TFT 632c is OFF then. Conversely, if no voltage is applied to the piezoelectric element portion, the TFT 632b is OFF and the TFT 632c is ON, and the control electrode 332 and the ground electrode 333 of the piezoelectric element portion 33 are therefore both connected to GND.

Directly attaching such a circuit substrate to the electrode end surface of the piezoelectric actuator 3 is advantageous for downsizing the head units 10 because it is not necessary to route wires between the piezoelectric actuator 3 and the circuit substrate.

With the head unit 10, the piezoelectric element portion 33 (the first piezoelectric layer 331) including the control electrode 332 is urged to stretch by applying a control potential to the control electrode 332 of the piezoelectric actuator 3 through the driving circuit, as described above. Then, a sliding occurs along the boundary plane at the sliding layer 35, whereby the piezoelectric element portion 33 easily protrudes into the pressure chamber 7, as shown in FIG. 10. Note that FIG. 10 exaggerates the protrusion of the piezoelectric element portion 33 for the sake of ease of understanding. The protrusion of the piezoelectric element portion 33 applies a pressure to the liquid in the pressure chamber 7, thereby discharging the liquid through the nozzle 12. By stopping the application of a control potential to the control electrode 332, the protruding piezoelectric element portion 33 returns to its original position, thereby loading the liquid into the pressure chamber 7.

In the piezoelectric actuator 3 of this configuration, the opposite ends of the piezoelectric element portion 33 (the first piezoelectric layer 331) in the X direction are supported by the fixed portions 34 (the second piezoelectric layer 341), and it is therefore possible to ensure a sufficient rigidity even if the thickness of the piezoelectric element portion 33 in the X direction is reduced. Therefore, the width of the pressure chamber 7 in the head unit 10 (the width in the left-right direction in FIG. 10) can be narrowed. This is advantageous for narrowing the nozzle pitch and increasing the resolution. While the length of the piezoelectric element portion 33 is set based on the length L (see FIG. 10) of the ground electrode 333, increasing the length L of the ground electrode 333 does not at all influence the rigidity of the piezoelectric element portion 33 since the piezoelectric element portion 33 is supported by the fixed portions 34. Moreover, the length L of the ground electrode 333 is the length in the height direction perpendicular to the X direction and the Y direction. Therefore, by setting the length L of the ground electrode 333, irrespective of dimensions related to the head unit 10, such as the nozzle pitch, it is possible to set the amount of displacement of the piezoelectric element portion 33 to any amount. This is advantageous for enabling the discharge of a high-viscosity liquid.

The provision of the sliding layer 35 between the piezoelectric element portion 33 and the fixed portion 34 significantly reduces the resistance force against the displacement of the piezoelectric element portion 33. As a result, the conversion efficiency of the piezoelectric actuator 3 is increased, allowing for the discharge of a high-viscosity liquid, for example.

The block-shaped piezoelectric actuator 3 is manufactured by laminating together a large number of green sheets (the piezoelectric sheets 501-504), as described above, which enables the piezoelectric actuator 3 including a large number of piezoelectric element portions 33 to be manufactured with a high precision and at a low cost. The employment of the laminated structure is advantageous also in that the control electrode 332 and the ground electrode 333 can be wired easily.

Note that while the piezoelectric actuator 3 here includes the first to fourth piezoelectric element rows 311-314, the number of piezoelectric element rows is not limited thereto. The number of piezoelectric element rows included in the piezoelectric actuator 3 may be set to any number by appropriately setting the number of convex portions in the piezoelectric sheet 5. For example, eight (first to eighth) convex portions may be provided in the first end portion P0 while doubling the width of the various piezoelectric sheets in the Y direction shown in FIG. 13. A piezoelectric actuator obtained by laminating together the piezoelectric sheets will include the first to eighth piezoelectric element rows. Here, the piezoelectric element portion 33 may be positioned at the same position in the X direction between the first and fifth piezoelectric element rows, between the second and sixth piezoelectric element rows, between the third and seventh piezoelectric element rows, and between the fourth and eighth piezoelectric element rows. That is, the piezoelectric element portions 33 in the first and fifth piezoelectric element rows are formed by the first and second piezoelectric sheets, the piezoelectric element portions 33 in the second and sixth piezoelectric element rows are formed by the second and third piezoelectric sheets, the piezoelectric element portions 33 in the third and seventh piezoelectric element rows are formed by the third and fourth piezoelectric sheets, and the piezoelectric element portions 33 in the fourth and eighth piezoelectric element rows are formed by the fourth and first piezoelectric sheets. In the head unit 10, a piezoelectric actuator including two piezoelectric element portions 33 at the same position in the X direction as described above will have two nozzles spaced apart from each other in the Y direction at the same position in the X direction. This is equivalent to the driving frequency of the head unit 10 being doubled.

Note that depending on the number of piezoelectric element rows included in the piezoelectric actuator, the types of piezoelectric sheets forming the piezoelectric actuator may be changed. That is, the types of piezoelectric sheets are not limited to the four types. For example, a piezoelectric actuator including first to third piezoelectric element rows may be produced by laminating together the first to third piezoelectric sheets. That is, the types of piezoelectric element rows included in the piezoelectric actuator correspond to the types of piezoelectric sheets. Here, piezoelectric element rows are of the same type if the positions in the X direction of the piezoelectric element portions 33 included therein are the same; and are of different types if the positions in the X direction of the piezoelectric element portions 33 are different from each other. Therefore, with the piezoelectric actuator including the first to eighth piezoelectric element rows described above, the piezoelectric element portions 33 are positioned at different positions in the X direction between the first, second, third and fourth piezoelectric element rows, whereas in a case where the piezoelectric element portions 33 are positioned at the same position in the X direction between the first and fifth piezoelectric element rows, between the second and sixth piezoelectric element rows, between the third and seventh piezoelectric element rows, and between the fourth and eighth piezoelectric element rows, the number of types of piezoelectric element rows included in this piezoelectric actuator is four.

(Variation 1)

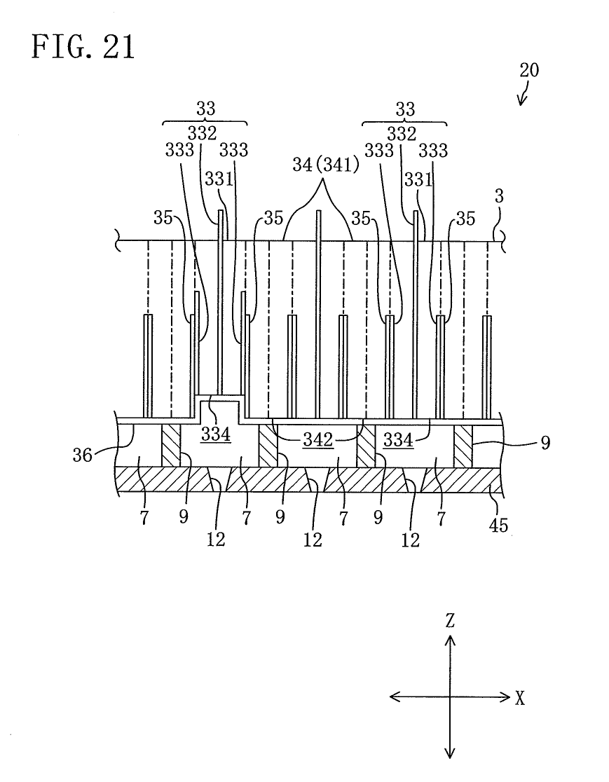

FIG. 21 shows a head unit 20 of Variation 1. In the head unit 20, the piezoelectric actuator 3 performs a so-called “push-pull operation.” That is, in the piezoelectric actuator 3, as a voltage is applied between the control electrode 332 and the ground electrode 333, the first piezoelectric layer 331 contracts, and the displaced end surface 334 of the piezoelectric element portion 33 is depressed as compared with the stationary end surface 342 of the fixed portion 34, thereby increasing the volume of the pressure chamber 7. When no voltage is applied after that state, the displaced end surface 334 of the piezoelectric element portion 33 returns to the original position, thereby applying a pressure to the liquid in the pressure chamber 7 and discharging the liquid through the nozzle 12.

With the head unit 20, a predetermined voltage is continuously applied to the control electrode 332 when the liquid is not discharged through the nozzle 12, whereas the voltage application is removed (the potential of the control electrode 332 is brought to the GND potential) when the liquid is discharged through the nozzle 12. As described above, when a voltage is applied to the piezoelectric element portion 33 to thereby displace the piezoelectric element portion 33, a period of time is required for the charge storing even if a constant voltage circuit is used. Therefore, there is a time lag between the voltage application and the displacement of the piezoelectric element portion 33. In contrast, when returning from the state where the piezoelectric element portion 33 is displaced with a voltage application to the original state (bringing the control electrode 332 to the GND potential), the signal AZB is turned ON (Hi), for example, with the constant voltage circuit 67 described above with reference to FIG. 20. Then, the TFT 632b will be turned OFF and the TFT 632c ON, and the control electrode 332 and the ground electrode 333 of the piezoelectric element portion 33 will be instantaneously connected to GND via a single TFT 632c. In the constant voltage circuit 67 shown in FIG. 20, a plurality of TFTs (two TFTs 632a and 632b) are connected in series on the power supply Vdd side, whereas a single TFT 632c is connected in series on the GND side. With this configuration, since the resistance value on the GND side is smaller, a smaller amount of time is typically required for discharging the piezoelectric element portion 33 with the piezoelectric element portion 33 connected to GND, as compared with a case where the piezoelectric element portion 33 is charged with the piezoelectric element portion 33 connected to the power supply Vdd. Thus, by improving the circuit configuration, the time lag from the discontinuation of the driving voltage application (connection to GND) until the displacement of the piezoelectric element portion 33 is made very small. Therefore, with the head unit 20 of the configuration above, the displacement speed of the piezoelectric element portion 33 is increased, thus providing a head advantageous particularly in the discharge of a high-viscosity liquid.

(Variation 2)

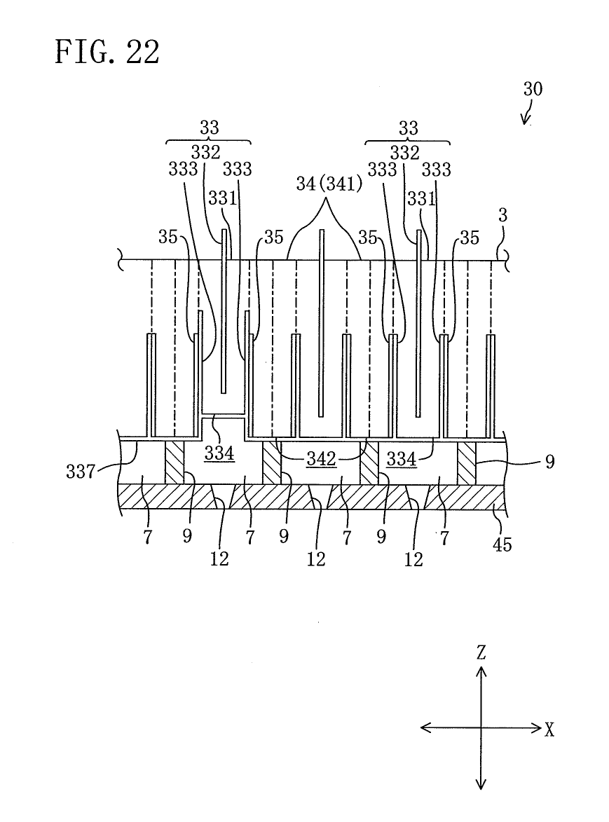

FIG. 22 shows a head unit 30 of Variation 2. In the head unit 30, a connection electrode 337 of the ground electrode 333 is formed along the driven end surface of the actuator block 3. The connection electrode 337 may be formed by performing a gold-plating process on the driven end surface of the actuator block 3, for example. Such a configuration eliminates the need for extending the connection electrode of the ground electrode 333 in the piezoelectric sheets 501-504 up to the second end side (the electrode end surface side) of the sheet, making the extraction of the ground electrode 333 even easier.

Note that with this configuration, it is necessary that the tip of the control electrode 332 is located inward with respect to the driven end surface in the actuator block 3, thereby preventing the shorting between the control electrode 332 and the ground electrode 333. This can easily be achieved by shifting the position of the control electrode 332 when printing the control electrode 332 on the piezoelectric sheet.

(Variation 3)

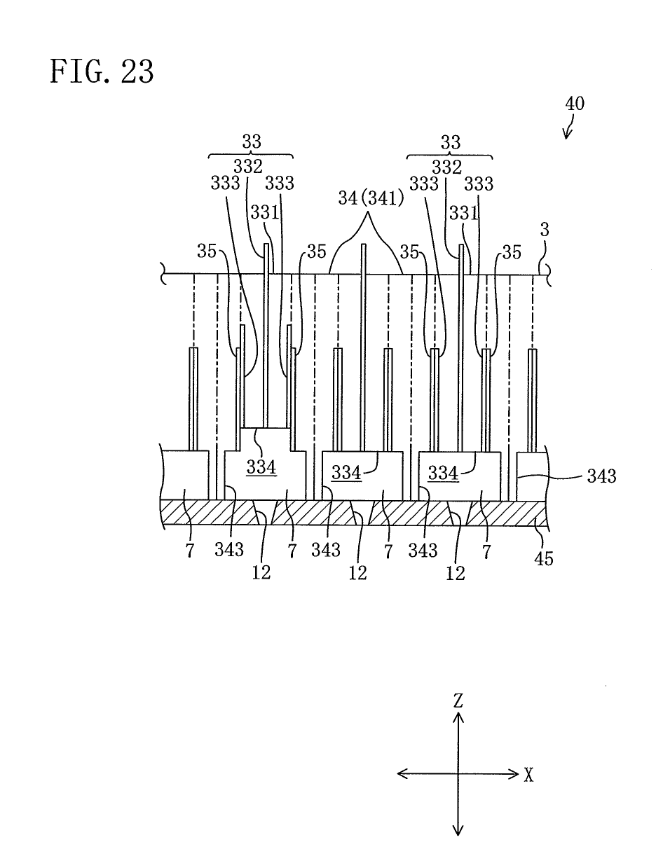

FIG. 23 shows a head unit 40 of Variation 3. In the head unit 40, portions corresponding to the pressure chamber partitioning members 9 (see FIG. 10, etc.) partitioning the pressure chambers 7 are formed by the piezoelectric actuator 3. That is, in the piezoelectric actuator 3, there are formed partition walls 343 protruding past the displaced end surface 334 of the piezoelectric element portion 33 at positions corresponding to the fixed portions 34, and the tips of the partition wall 343 are attached to the nozzle plate 45. Thus, the pressure chambers 7 are partitioned by the driven end surface of the piezoelectric element row 31 (see the left diagram of FIG. 9), the partition wall 343 and the nozzle plate 45.

The piezoelectric actuator 3 of this configuration can be produced by the following procedure. That is, as in the process for manufacturing the piezoelectric actuator 3 described above, the piezoelectric sheets 5 are provided by printing electrodes, etc., on green sheets cut out in a predetermined rectangular shape. In the piezoelectric sheet 5, the protrusion height of the convex portions 51-54 is set to be even higher than that of the convex portions 51-54 shown in FIG. 13, etc. This is to include the height corresponding to the height of the partition wall 343 (i.e., the height of the pressure chamber 7). Then, the piezoelectric sheets 5 are laminated together in a predetermined order as described above, and the laminate is sintered while being compressed in the lamination direction, thereby producing a block-shaped piezoelectric actuator.

After the block-shaped piezoelectric actuator 3 is produced, it is cut in the X direction at positions of the concave grooves in the first end portion thereof, thereby finishing the shape of the piezoelectric element rows 311-314 extending in the lamination direction (the X direction) (see FIG. 11).

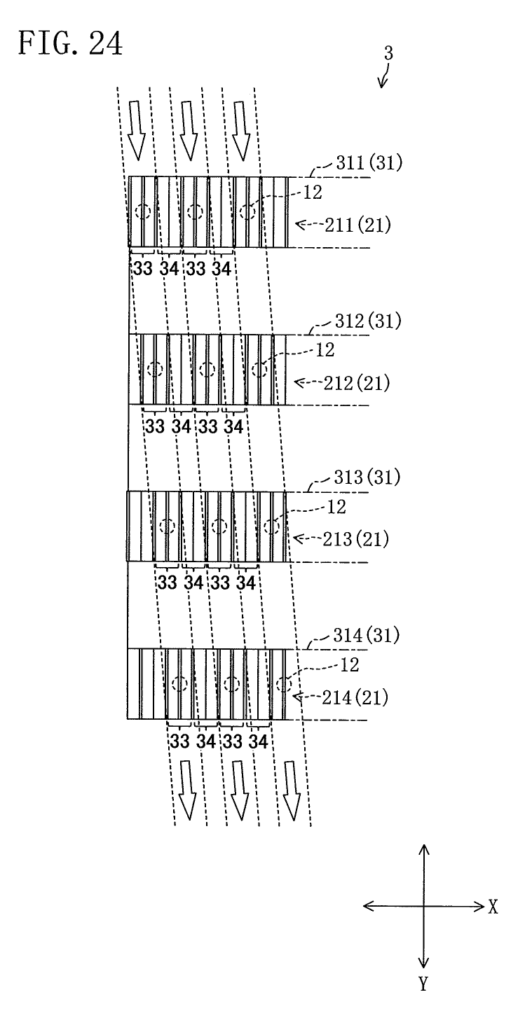

By cutting the first end portion (the driven end surface side) in the Y direction, as indicated by outline arrows in FIG. 24, the displaced end surface 334 of the piezoelectric element portion 33 and the partition wall 343 are formed. Specifically, a cutting process is performed in an inclined direction with respect to the Y direction so as to pass positions corresponding to the piezoelectric element portions 33 in the first to fourth piezoelectric element rows 311-314. The cutting process is performed for each of a plurality of positions different from each other in the X direction. Thus, the cut portion becomes the displaced end surface 334 of the piezoelectric element portion 33 (the upper surface of the pressure chamber 7), and the uncut portion becomes the partition wall 343 (opposite side surfaces of the pressure chamber 7 in the X direction). Such a configuration is advantageous for reducing the number of parts or reducing the number of assembly steps.

(Variation 4)

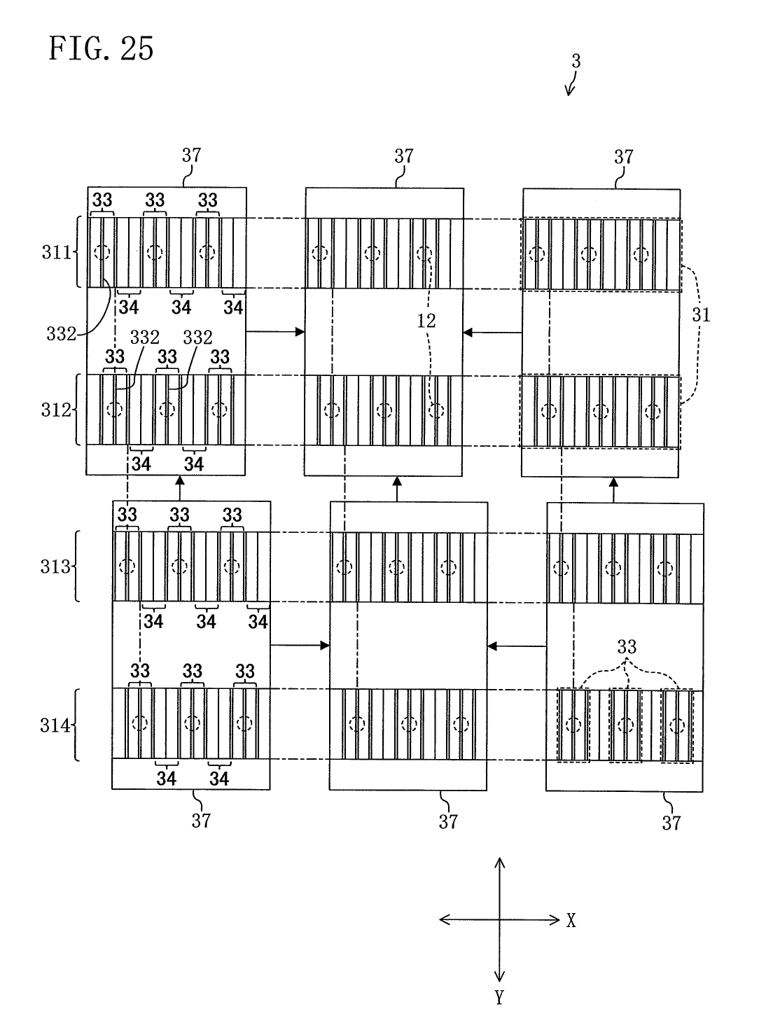

Variation 4 is directed to the manufacture of the piezoelectric actuator 3. In this variation, a plurality of blocks (separate blocks 37) of the piezoelectric actuator 3 including the first to fourth piezoelectric element rows 311-314 (see FIGS. 9 and 11) are produced separately, and they are then attached together to thereby produce a single piezoelectric actuator 3. Specifically, a plurality of separate blocks 37 are provided, each including two piezoelectric element rows 31 and three piezoelectric element portions 33 for each piezoelectric element row 31, as shown in FIG. 25, for example. The number of piezoelectric element rows 31 included in a separate block 37, and the number of piezoelectric element portions 33 included in each piezoelectric element row 31 may be set appropriately.

Such a separate block 37 may be manufactured by laminating together, and sintering, a plurality of piezoelectric sheets 5, as in the method for manufacturing the piezoelectric actuator 3 described above. The number of piezoelectric sheets 5 to be laminated together in the separate block 37 may be set to be relatively small so that the manufacture of the separate blocks 37 will be relatively easy. Note that the number of piezoelectric sheets 5 laminated together in the separate block 37 may be set to be any number as long as it satisfies the condition that the control electrode 332 is not exposed on the side surface of the separate block. The separate blocks 37 may alternatively be produced by first producing a block of a relatively large size and then dicing the block.

After a plurality of separate blocks 37 are produced, the plurality of separate blocks 37 are attached together. Specifically, with respect to the X direction, a plurality of separate blocks 37 may be attached together without shifting the positions thereof from one another in the Y direction. Thus, the piezoelectric element row 31 extends continuously in the X direction. On the other hand, with respect to the Y direction, a plurality of separate blocks 37 are attached together while shifting the positions thereof from one another in the X direction. Thus, the piezoelectric actuator 3 includes the first to fourth piezoelectric element rows 311-314, and the positions of the nozzles 12, or the positions of the piezoelectric element portions 33, are shifted in the X direction by one piezoelectric sheet between the piezoelectric element rows 311-314 adjacent to one another in the Y direction. Thus, the piezoelectric actuator 3 having a predetermined nozzle pitch is manufactured.

As described above, such a separate block 37 can be produced relatively easily because the number of piezoelectric sheets 5 laminated together is small. Therefore, the manufacturing method makes the manufacture of the piezoelectric actuator 3 easier, and improves the production yield of the head unit as a final product. Note that while a piezoelectric actuator 3 is produced by attaching together six separate blocks 37, the number of separate blocks 37 to be attached together is not limited thereto. Alternatively, a plurality of separate blocks may be attached together only in the X direction, for example.

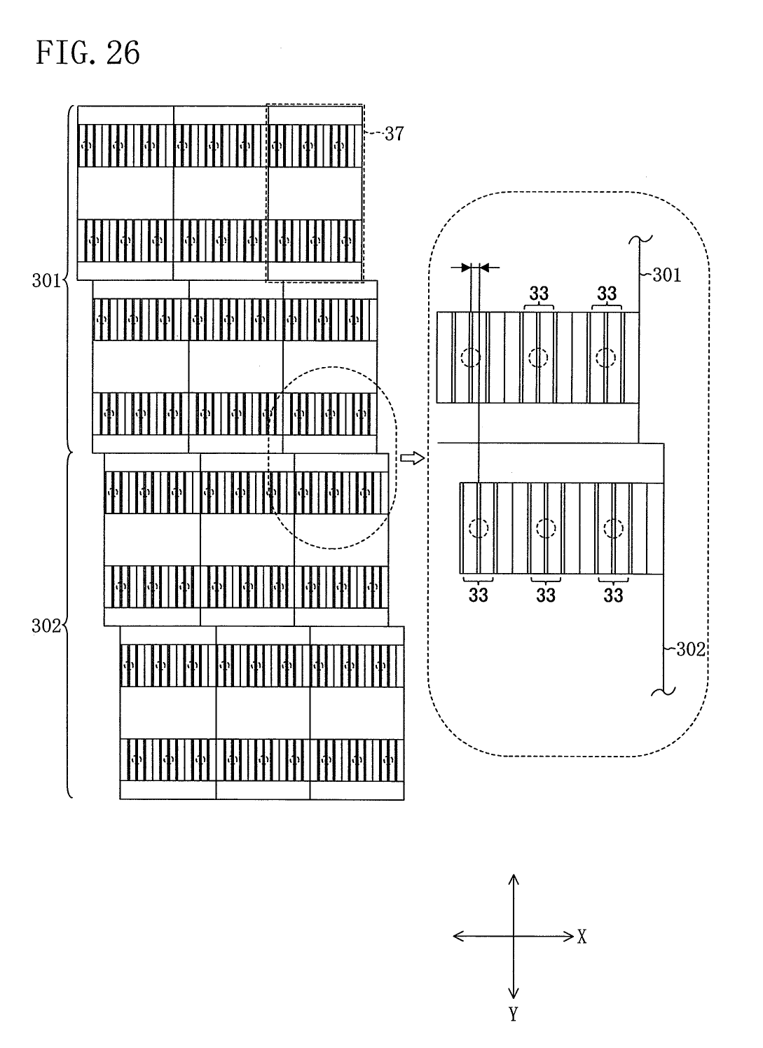

FIG. 26 shows an example where two piezoelectric actuators 3 are provided, each produced by attaching together the separate blocks 37 described above, and a first piezoelectric actuator 301 and a second piezoelectric actuator 302 are further attached together in the Y direction, thereby providing a single piezoelectric actuator. As shown on an enlarged scale in the right diagram of the figure, the first piezoelectric actuator 301 and the second piezoelectric actuator 302 are attached together so that the positions of the piezoelectric element portion 33 in the X direction are shifted from each other by the half thickness of one piezoelectric sheet. Then, a head unit using a piezoelectric actuator obtained by attaching together the first and second piezoelectric actuators 301 and 302 will have a resolution in the X direction that is twice that achieved with the first or second piezoelectric actuator alone.

(Variation 5)

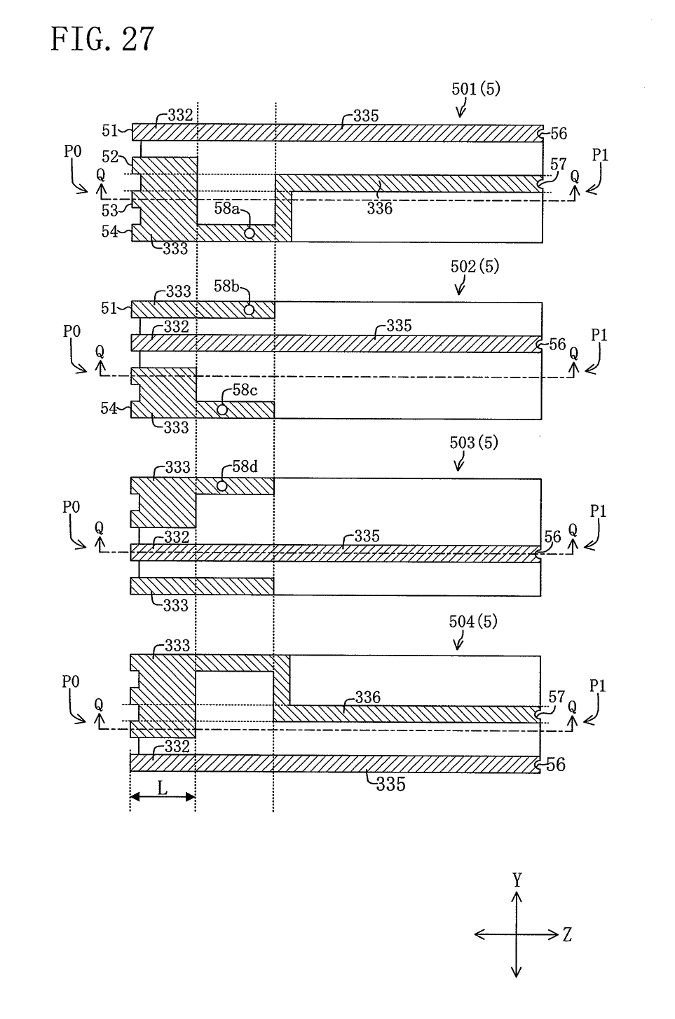

FIG. 27 illustrates a variation of an electrode pattern of a piezoelectric sheet. Referring to FIG. 27, the pattern for extracting the ground electrode 333 in the piezoelectric sheet 5 to the electrode end surface P1 will now be described in detail. Note that FIG. 27 does not show the sliding layers 35 for the sake of simplicity.

Also in this variation, the piezoelectric actuator 3 is formed by repeatedly laminating together the four different piezoelectric sheets 5, i.e., the first piezoelectric sheet 501, the second piezoelectric sheet 502, the third piezoelectric sheet 503 and the fourth piezoelectric sheet 504. In any of the piezoelectric sheets 5, the control electrode 332 is extracted straight to the electrode end surface P1 side by the connection electrode 335. On the other hand, the ground electrode 333 is extracted to the electrode end surface P1 side by the connection electrode 336 for two piezoelectric sheets, i.e., the first piezoelectric sheet 501 and the fourth piezoelectric sheet 504.

The lower surface (the surface on which electrodes, etc., are not formed) of the first piezoelectric sheet 501 contacts the upper surface (the surface on which electrodes, etc., are formed) of the second piezoelectric sheet 502. Similarly, the lower surface of the second piezoelectric sheet 502 contacts the upper surface of the third piezoelectric sheet 503, the lower surface of the third piezoelectric sheet 503 contacts the upper surface of the fourth piezoelectric sheet 504, and the lower surface of the fourth piezoelectric sheet 504 contacts the upper surface of the first piezoelectric sheet 501, next in the repetitive lamination. In an actual manufacturing process, the third piezoelectric sheet 503 is laid on the fourth piezoelectric sheet 504, the second piezoelectric sheet 502 is next laid thereon, and the first piezoelectric sheet 501 is next laid thereon. If the lamination continues, the fourth piezoelectric sheet 504 is next laid thereon, and so on.

A through hole 58d is formed in the third piezoelectric sheet 503, and the ground electrodes 333 of the fourth piezoelectric sheet 504 and the third piezoelectric sheet 503 are electrically connected together by laying the third piezoelectric sheet 503 on the fourth piezoelectric sheet 504 and injecting a conductive material into the through hole 58d. Through holes 58b and 58c are formed in the second piezoelectric sheet 502, and the ground electrodes 333 (two-part electrodes) of the third piezoelectric sheet 503 and the second piezoelectric sheet 502 are electrically connected together by laying the second piezoelectric sheet 502 on the third piezoelectric sheet 503 (which is already laminated with the fourth piezoelectric sheet 504 as described above) and injecting a conductive material into the through holes 58b and 58c. Similarly, the ground electrodes 333 of the second piezoelectric sheet 502 and the first piezoelectric sheet 501 are connected together via a through hole 58a provided in the first piezoelectric sheet 501. As a result, by laminating the four piezoelectric sheets 5 together, all the ground electrodes 333 are electrically connected together.

As described above, by the connection electrodes 336 provided in the first piezoelectric sheet 501 and the fourth piezoelectric sheet 504, the ground electrodes 333 of the piezoelectric sheets 5 are electrically connected to a common electrode concave portion 57 provided on the electrode end surface P1.

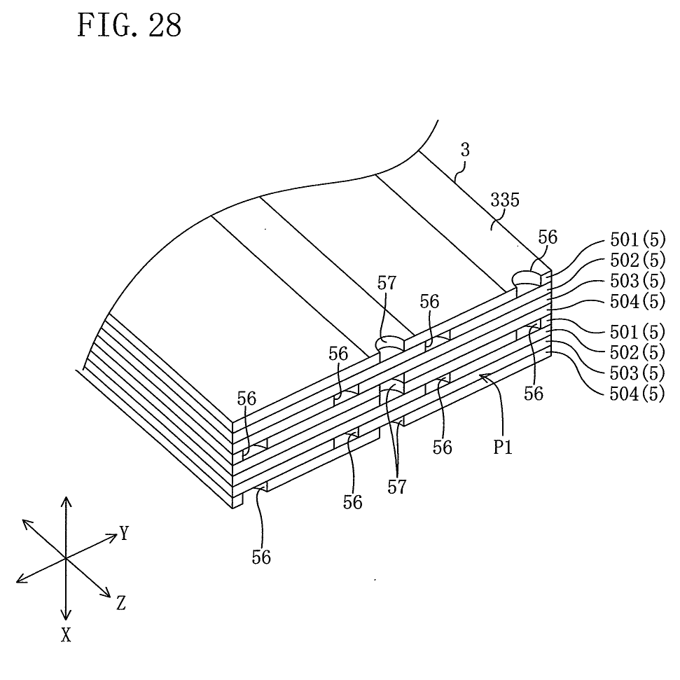

FIG. 28 is a perspective view of a main part showing piezoelectric sheets laminated together in the piezoelectric actuator of Variation 5. FIG. 28 shows what is obtained by laying eight piezoelectric sheets 5 on one another in the order described above, as viewed from the electrode end surface P1 side. As shown in FIG. 28, the electrode concave portions 56 electrically connected to the control electrodes 332 (see FIG. 27) are exposed/formed on the electrode end surface P1 while being separated in the X direction and in the Y direction. Then, the common electrode concave portions 57 connected to the ground electrodes 333 are exposed/formed in limited areas along the lamination direction (the X direction) of the piezoelectric sheets 5.

Bumps may be formed in the electrode concave portions 56 and the common electrode concave portions 57 thus exposed, and connected to the substrate including TFTs formed thereon, for example. With such a configuration as described above, since the common electrode (ground) can be provided in a localized manner in a portion of the electrode end surface P1, the ground potential will fluctuate less, and the TFT substrate to be attached to the electrode end surface P1 may have separated circuit configurations on the left and on the right of the ground, thus allowing for an increase in the degree of freedom in designing the transistor layout, or the like, in the left and right areas.

(Variation 6)

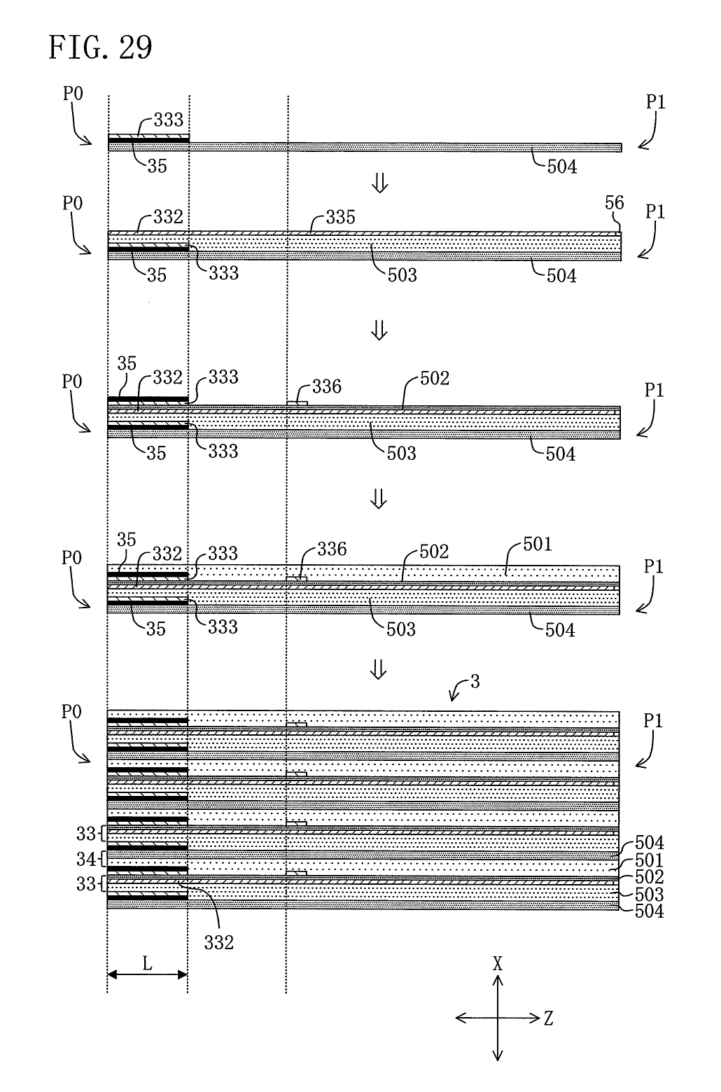

FIG. 29 is a cross-sectional view showing a manufacturing process of a piezoelectric actuator. Referring to FIG. 29, the method for manufacturing a piezoelectric actuator will be described in detail. As reference numerals to be used in the description, those discussed above already will be used as they are. Note that the routing pattern of the control electrodes 332 and the ground electrodes 333 shown in FIG. 28 is used in the following description, and FIG. 29 is a cross-sectional view along Q-Q where the piezoelectric sheets 5 are repeatedly laminated in the order from the bottom diagram to the top diagram of FIG. 27. Although FIG. 29 shows the sliding layers (sliding layers) 35, the control electrodes 332 and the ground electrodes 333 to be thicker, the actual thicknesses of the sliding layers 35, the control electrodes 332 and the ground electrodes 333 are set to be about 50 nm, as already explained above, and are very thin as compared with the thickness of the piezoelectric sheet 5 (e.g., 34 μm).

<Step (i)> (Uppermost Diagram of FIG. 29)

First, on the upper surface of the fourth piezoelectric sheet 504, the sliding layer 35 and the second electrode 333 as a common electrode are formed in this order by using a printing method (e.g., ink jet method) on the driven end surface P0 side.

<Step (ii)> (Second Diagram from the Top of FIG. 29)

Next, the third piezoelectric sheet 503 is laminated on the fourth piezoelectric sheet 504 so as to sandwich the sliding layer 35 and the second electrode 333 therebetween. Then, on the upper surface of the laminated third piezoelectric sheet 503, the first electrode 332 as a control electrode and the connection electrode 335 to be extracted therefrom are formed by using a printing method (e.g., ink jet method) on the driven end surface P0 side. The connection electrode 335 is extended to the electrode end surface P1, and forms the electrode concave portion 56 on the electrode end surface P1.

Note that for the formation of the electrode concave portion 56, the through holes 56a (see FIG. 16) may first be formed and portions thereof on the electrode end surface P1 side may be cut off so that the electrode concave portions 56 will be exposed eventually, instead of directly forming the concave portions.

In step (ii), the second electrode 333 shown in the third diagram from the top of FIG. 27 is formed at the same time. Then, a conductive material such as a conductive paste is injected into the through hole 58d, not appearing in FIG. 29.

<Step (iii)> (Third Diagram from the Top of FIG. 29)

Then, the second piezoelectric sheet 502 is laminated on the third piezoelectric sheet 503 with the first electrode 332 as a control electrode, etc., formed thereon so that the first electrode 332, etc., are sandwiched therebetween. Then, on the upper surface of the second piezoelectric sheet 502, the second electrode 333 as a common electrode and the sliding layer 35 are formed in this order by using a printing method (e.g., ink jet method) on the driven end surface P0 side. Then, the second electrode 333 and the sliding layer 35 are formed at a position opposing the sliding layer 35 and the second electrode 333 formed in <step (ii)>.

In step (iii), the second electrode 333 shown in the second diagram from the top of FIG. 27 is formed at the same time. Then, a conductive material such as a conductive paste is injected into the through holes 58b and 58c, not appearing in FIG. 29.

<Step (iv)> (Fourth Diagram from the Top of FIG. 29)

Then, the first piezoelectric sheet 501 is laminated on the second piezoelectric sheet 502 with the second electrode 333 as a common electrode, etc., and the sliding layer 35 formed thereon so that the second electrode 333 and the sliding layer 35 are sandwiched therebetween.

By repeating these steps <i> to <iv>, the piezoelectric actuator 3 shown in the lowermost diagram of FIG. 29 is formed. On the driven end surface P0 of the piezoelectric actuator 3, the piezoelectric element portion 33 and the fixed portion 34 (i.e., the displaced end surface 334 and the stationary end surface 342) are formed alternating with each other in the X direction.

<Step (v)>

The piezoelectric actuator 3 obtained as described above is sintered at a predetermined temperature for a predetermined period of time, thereby manufacturing a piezoelectric actuator as a final product. In response to the application of a predetermined potential between the control electrode 332 and the ground electrode 333 of this piezoelectric actuator, the second piezoelectric sheet 502 and the third piezoelectric sheet 503 are displaced in the height direction.

As described above, the method for manufacturing the piezoelectric actuator 3 illustrated herein is a method for manufacturing a piezoelectric actuator provided with a displaced portion L on the laminate end surface (the driven end surface P0) formed by laminating together a plurality of piezoelectric sheets (501-504), the displaced portion L being displaced in the normal direction to the laminate end surface (the height direction), wherein the piezoelectric sheets (501-504), the sliding layers 35 for reducing the friction in the sliding direction between the laminated piezoelectric sheets, the control electrodes 332 and the ground electrodes 333 are laminated on the laminate end surface, wherein

a piezoelectric sheet A (the fourth piezoelectric sheet 504), the sliding layer 35, the ground electrode 333, a piezoelectric sheet B (the third piezoelectric sheet 503), the control electrode 332, a piezoelectric sheet C (the second piezoelectric sheet 502), the ground electrode 333, the sliding layer 35, and a piezoelectric sheet D (the first piezoelectric sheet 501)

are repeatedly laminated together in this order.

The method for manufacturing the piezoelectric actuator 3 illustrated herein includes the steps of:

i) forming (in this order), in a portion corresponding to the displaced portion L of a piezoelectric sheet A (the fourth piezoelectric sheet 504), the sliding layer 35 for reducing the friction in the sliding direction between the laminated piezoelectric sheets and the ground electrode 333;

ii) laminating a piezoelectric sheet B (the third piezoelectric sheet 503) on the piezoelectric sheet A (the fourth piezoelectric sheet 504) so that the sliding layer 35 and the ground electrode 333 formed in the step i) are sandwiched therebetween, and forming the control electrode 332 in a portion of the piezoelectric sheet B corresponding to the displaced portion L;

iii) laminating a piezoelectric sheet C (the second piezoelectric sheet 502) on the piezoelectric sheet B (the third piezoelectric sheet 503) so that the control electrode 332 formed in the step ii) is sandwiched therebetween, and forming (in this order) the ground electrode 333 and the sliding layer 35 in a portion of the piezoelectric sheet C corresponding to the displaced portion L;

iv) laminating a piezoelectric sheet D (the first piezoelectric sheet 501) on the piezoelectric sheet C (the second piezoelectric sheet 502) so that the ground electrode 333 and the sliding layer 35 formed in the step iii) are sandwiched therebetween; and

v) sintering the laminate produced through the above steps.

(Variation 7)

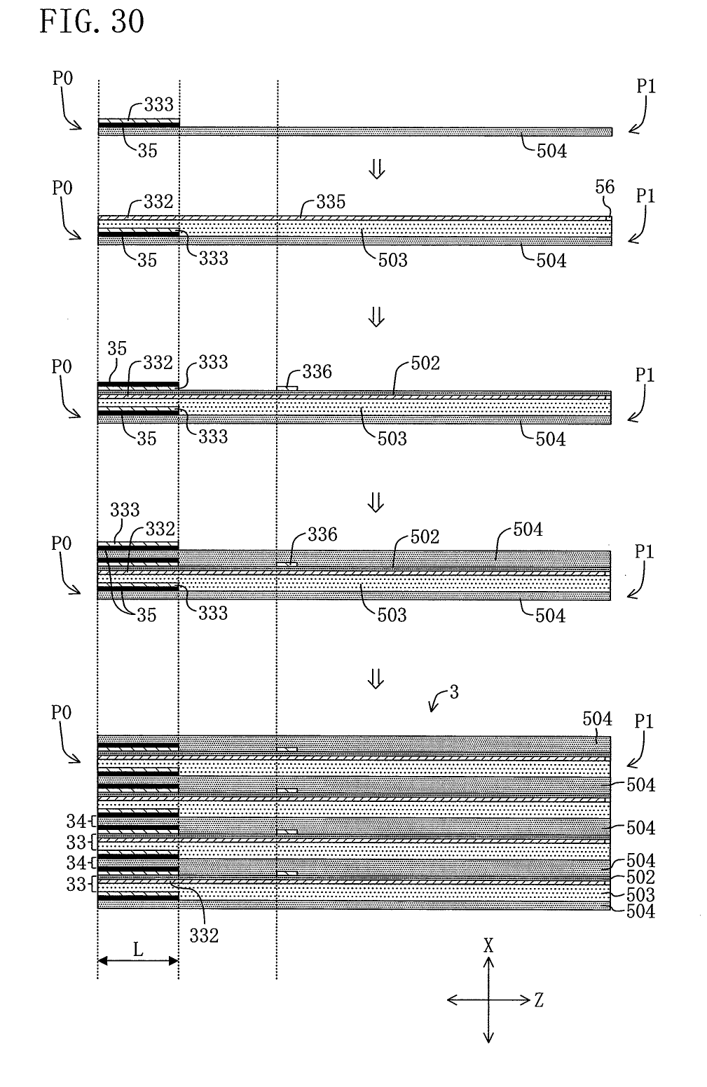

FIG. 30 is a cross-sectional view showing the structure of a piezoelectric actuator of Variation 7 and a manufacturing process thereof. According to Variation 7, it is possible to form a piezoelectric actuator more easily and with a higher density. In Variation 7, when piezoelectric sheets are laminated together, <step (i)> to <step (iii)> are repeated while omitting <step (iv)> of Variation 6, and the product is sintered thereafter.

That is, in Variation 6, after the first piezoelectric sheet 501 is laminated, the fourth piezoelectric sheet 504 is laminated in the following step (resulting in a configuration shown in the lowermost diagram of FIG. 29) as shown in the fourth diagram from the top of FIG. 29. In Variation 7, the fourth piezoelectric sheet 504 is laminated and the sliding layer 35 and the second electrode 333 are formed directly on the fourth piezoelectric sheet 504 in the step after the second piezoelectric sheet 502 is laminated as shown in the fourth diagram from the top of FIG. 30. As a result, the piezoelectric actuator 3 has a configuration shown in the lowermost diagram of FIG. 30.

In Variation 6, the piezoelectric element portion 33 is formed by two piezoelectric sheets in the X direction, and the fixed portion 34 is formed by two piezoelectric sheets. On the other hand, in Variation 7, it can be seen that the piezoelectric element portion 33 is formed by two piezoelectric sheets in the X direction, and the fixed portion 34 is formed by a single piezoelectric sheet. With this configuration, since the number of piezoelectric sheets forming a unit of the piezoelectric actuator 3 is reduced by one, it is possible to reduce the cost, improve the yield and further reduce the nozzle pitch in the X direction.

As described above, the method for manufacturing the piezoelectric actuator 3 illustrated herein is a method for manufacturing a piezoelectric actuator provided with a displaced portion L on the laminate end surface (the driven end surface P0) formed by laminating together a plurality of piezoelectric sheets (502-504), the displaced portion L being displaced in the normal direction to the laminate end surface (the height direction), wherein the piezoelectric sheets (502-504), the sliding layers 35 for reducing the friction in the sliding direction between the laminated piezoelectric sheets, the control electrodes 332 and the ground electrodes 333 are laminated on the laminate end surface, wherein

a piezoelectric sheet A (the fourth piezoelectric sheet 504), the sliding layer 35, the ground electrode 333, a piezoelectric sheet B (the third piezoelectric sheet 503), the control electrode 332, a piezoelectric sheet C (the second piezoelectric sheet 502), the ground electrode 333, and the sliding layer 35

are repeatedly laminated together in this order.

The method for manufacturing the piezoelectric actuator 3 illustrated herein includes the steps of:

i) forming (in this order), in a portion corresponding to the displaced portion L of a piezoelectric sheet A (the fourth piezoelectric sheet 504), the sliding layer 35 for reducing the friction in the sliding direction between the laminated piezoelectric sheets and the ground electrode 333;

ii) laminating a piezoelectric sheet B (the third piezoelectric sheet 503) on the piezoelectric sheet A (the fourth piezoelectric sheet 504) so that the sliding layer 35 and the ground electrode 333 formed in the step i) are sandwiched therebetween, and forming the control electrode 332 in a portion of the piezoelectric sheet B corresponding to the displaced portion L;

iii) laminating a piezoelectric sheet C (the second piezoelectric sheet 502) on the piezoelectric sheet B (the third piezoelectric sheet 503) so that the control electrode 332 formed in the step ii) is sandwiched therebetween, and forming (in this order) the ground electrode 333 and the sliding layer 35 in a portion of the piezoelectric sheet C corresponding to the displaced portion L; and

iv) sintering the laminate produced through the above steps.

### Other Embodiments

The number of piezoelectric element rows and the number of piezoelectric element portions included in the piezoelectric actuator 3 and the arrangement thereof are not limited to those of the embodiments above. Any combination of the embodiments above may be used as long as such a combination is possible.

The piezoelectric actuator 3 is not limited to being an actuator for a liquid discharging head, but may be used in various other devices.

The liquid discharging head is not limited to device-manufacturing applications, but may be used as a so-called “ink jet head” for forming an image by discharging an ink onto a recording medium.

As described above, the present disclosure is useful for a piezoelectric actuator, and a liquid discharging head and a liquid discharging apparatus having the same, and is widely applicable to an ink jet printer, and an organic EL panel manufacturing apparatus, a wiring pattern drawing apparatus, etc., using an ink jet method, for example.

1-21. (canceled)

22. A liquid discharging head comprising:
a piezoelectric actuator;
at least one pressure chamber a portion of which is partitioned by the piezoelectric actuator; and
at least one nozzle communicating with the pressure chamber,
wherein the piezoelectric actuator is driven to apply a pressure on a liquid loaded in the pressure chamber, thereby discharging a droplet through the nozzle,
the piezoelectric actuator comprising:
a piezoelectric sheet having a front surface and a reverse surface, wherein an end surface thereof between the front surface and the reverse surface partitions a portion of the pressure chamber;
a first electrode provided on the front surface of the piezoelectric sheet;
a second electrode provided on the reverse surface of the piezoelectric sheet and opposing at least a portion of the first electrode;
a fixed portion for supporting the piezoelectric sheet with the first and second electrodes provided thereon from a front surface side and a reverse surface side of the piezoelectric sheet; and
a sliding layer provided between the fixed portion and the first electrode and between the fixed portion and the second electrode so as to allow for a relative displacement between the piezoelectric sheet and the fixed portion.

23. The liquid discharging head of claim 22, wherein
a cover layer is provided between the piezoelectric actuator and the pressure chamber.

24. The liquid discharging head of claim 22, further comprising:
a circulation passageway for supplying the liquid to the pressure chamber; and
a filter provided at a point along the circulation passageway.

25. The liquid discharging head of claim 22, wherein
the nozzles are arranged so as to form a nozzle row inclined with respect to a primary scanning direction,
the piezoelectric actuator includes a plurality of actuator blocks each formed by laminating together a plurality of laminates with the fixed portions sandwiched therebetween, wherein each of the laminates is obtained by laminating together the piezoelectric sheet, the first and second electrodes and the sliding layer,
the plurality of actuator blocks are arranged side-by-side in the primary scanning direction, and each actuator block is arranged while being inclined with respect to the primary scanning direction so that a direction in which the end surface of the piezoelectric sheet extends coincides with the inclined nozzle row.

26-47. (canceled)
